(19) United States
(12) Patent Application Publication
(10) Pub. No.: US 2025/0232209 A1
(43) Pub. Date: Jul. 17, 2025

(54) AUTOMATED PLATFORM, METHOD, AND SYSTEM TO RECOGNIZE FOOD ITEMS USING ARTIFICIAL INTELLIGENCE

(71) Applicant: Marvin Tiebout, Perth (AU)

(72) Inventor: Marvin Tiebout, Perth (AU)

(21) Appl. No.: 18/412,626

(22) Filed: Jan. 15, 2024

(51) Int. Cl. G06N 20/00

(52) U.S. Cl. CPC G06N 20/00

(57) ABSTRACT

An automated food recognition platform comprises a memory, processor, and various submodules, utilizing artificial intelligence to analyze digital media (images, photos, audiovisual) for food identification and attributes. It includes an edible food database and recipe submodule, generating personalized recipes considering dietary preferences. The automated food recognition platform also features allergy and drug interaction submodules, informing users of relevant information. A marketplace submodule tracks inventory levels, enhancing recipe recommendations. Leftover identification and meal planning submodules offer creative cooking solutions. An interactive submodule fosters a chef-user community, incorporating user feedback and social media data to refine recipe recommendations. Chefs receive compensation based on a chef rating, determined by user interactions. The platform promotes chef recipes through paid advertising services within the interactive submodule.

### FIELD OF TECHNOLOGY

The present invention relates generally to the field of digital image processing and artificial intelligence. More specifically, the invention pertains to an automated platform, method, and system to recognize food items using artificial intelligence and providing recipe recommendations and dietary management based on the identified food items.

### BACKGROUND

A food recognition device may intake digital media and may utilize a machine learning model to recognize a food item. Recently there has been a growing interest in leveraging technology such as the food recognition device to assist individuals with dietary planning, nutritional analysis, and food-related decision-making. Traditional methods of identifying food items and their nutritional content may require manual input and may be limited by the user's knowledge of food ingredients and their nutritional value. Additionally, the task of matching food items with suitable recipes and dietary preferences may be time-consuming and may be prone to error, especially when considering factors like allergies, dietary restrictions, and personal taste preferences.

The food recognition device may scan a barcode in a mobile application to allow users to retrieve nutritional information about packaged foods. However, this approach may be limited to processed and pre-packaged products and may not extend to fresh or homemade foods. The food recognition device may utilize basic image recognition technologies to identify food items, but these may lack accuracy and may fail to provide comprehensive information about the food, such as its source, taste profile, and/or potential allergens.

Moreover, the food recognition device may not adequately integrate the recognition of food items with personalized dietary management. The food recognition system may lack the capability to consider the user's unique dietary preferences, restrictions, and cooking skills when recommending recipes or dietary plans. The food recognition device may fail to integrate real-time marketplace inventory levels with food recognition and recipe recommendation systems. The absence of real-time integration with marketplace inventory levels for obtaining ingredients may inhibit a user's ability to create recipes containing items other than the food ingredients.

### SUMMARY

Disclosed is an automated platform, method, and system to recognize food items using artificial intelligence.

In one aspect, an automated food recognition platform includes a memory and a processor communicatively coupled to the memory. The processor executes instructions stored in the memory. An electronic device transmits a digital media to an artificial intelligence model via a network. The digital media is a digital media file, an image, a photograph, and/or an audiovisual media. An edible food database stored on the memory as a nonvolatile memory. A food identification module within the artificial intelligence model analyzes the digital media transmitted by the electronic device, identifying a food ingredient within the digital media. An information submodule automatically identifies an attribute of the food ingredient, such as a source of origin, a taste profile, a nutritional content, a food component, and/or a cooking method of the food ingredient.

The automated food recognition platform may include a recipe database stored on the memory as the nonvolatile memory. A recipe submodule may be communicatively coupled to the recipe database and the food identification module. The recipe submodule may receive outputs from the food identification module and the food information submodule and compare these outputs with a plurality of recipes listed in the recipe database using a mapping algorithm. The recipe submodule may generate a recommended recipe for a user of the electronic device based on the outputs of the mapping algorithm, and the recipes within the recommendation may contain the food ingredient. A structured set of food data may be formed from the digital media which is then stored within the edible food database. The artificial intelligence model may be trained using the structured set of food data. An allergy submodule may automatically identify and inform the user via the electronic device of at least one allergic quality of the food ingredient.

A drug interaction submodule may identify and inform the user via the electronic device of at least one attribute that interacts with at least one drug component. The recipe submodule may consider a dietary preference, a food restriction, and/or a cooking skill level of the user when generating the recommended recipe. A marketplace submodule may identify an inventory level of a complementary item and the food ingredient at a vendor. The complementary item may be part of the recommended recipe. The vendor may communicate the inventory level of the food ingredient and the complementary item to the marketplace submodule over the network. The inventory level of the food ingredient and the complementary item may be communicated to the electronic device. An inventory level database may process information from the vendor to update the vendor's inventory levels of the food ingredient and the complementary item within the marketplace submodule. The inventory levels of the food ingredient and the complementary item may be viewable to the user on the electronic device. The inventory level of the food ingredient and the inventory level of the complementary item for the vendors within the marketplace may be input into the mapping algorithm of the recipe submodule and used to refine selecting the recommended recipe.

A leftover identification submodule within the artificial intelligence model may identify at least one leftover ingredient from the digital media. The leftover ingredient may be input to the mapping algorithm of the recipe submodule, and the recipe submodule may recommend the recommended recipe based on the leftover ingredient and/or the food ingredient. A meal planning submodule may allow the user to create a meal plan based on the recommended recipe and/or a secondary recipe identified by the recipe submodule. The meal planning submodule may communicate with the marketplace submodule and recommend meal plans based on the inventory level of the complementary item in the plurality of vendors within a particular geographical region. An interactive submodule may include an online community of a plurality of chefs. The chefs within the community of chefs may have a chef profile displaying a chef name, a photo, a biography, a recipe board, and/or a weblink. The individual chefs may use the interactive submodule to share a custom recipe to the recipe database and the chef profile associated with that individual chef.

The users may critique the custom recipe with user feedback. The user feedback may be viewable on the chef profile associated with the custom recipe. The mapping algorithm of the recipe submodule may incorporate the user feedback and/or social media feedback to refine the selection of the recommended recipe from the recipe submodule. The social media feedback may be an automatically compiled dataset of comments about the custom recipe from a plurality of social media platforms. A chef rating may be created from the user feedback and/or social media feedback. The chef rating may be viewable on the chef profile. The chefs may receive compensation based on the chef rating generated from recipe feedback and/or interactions. The interactions may be a recommendation frequency and/or chef profile visits. The recommendation frequency may be the frequency that the chef's custom recipe is included in the recommended recipe output by the recipe submodule.

In another aspect, a method includes training an artificial intelligence model with an edible food database with a structured set of food data stored as a nonvolatile memory. The method includes analyzing a digital media with the artificial intelligence model to identify at least one food ingredient within the digital media. The digital media is an image, a photograph, and/or an audiovisual media. The digital media is transferred to the artificial intelligence from an electronic device via a network. The digital media is transformed into the structured set of food data and trains the artificial intelligence model. The method also involves identifying an attribute of the food ingredient using a food information submodule, where the attribute is a source of origin, a taste profile, a nutritional content, a food component, and/or a cooking method. Additionally, the method includes generating a plurality of recommended recipes using a recipe submodule based on the food ingredient and/or the attribute. The food ingredient and/or the attribute are compared with the recipe database using a mapping algorithm. The recipe submodule generates the plurality of recommended recipes for a user of the electronic device based on a dietary preference, a food restriction, and/or a cooking skill level using the food ingredient, and the recipe contains the food ingredient.

The method may include accessing an inventory level of a complementary item and/or the food ingredient from a marketplace submodule. The complementary item may be part of the recommended recipes. The method may include communicating the inventory level of the food ingredient and/or the complementary item from the marketplace submodule to the electronic device via the network. The method may further include processing inventory level information of the food ingredient and/or the complementary item from a plurality of vendors using an inventory level database. The method may include displaying the inventory levels of the food ingredient and the complementary item to the user on the electronic device. The method may further include identifying a leftover ingredient from the digital media using the leftover identification submodule within the artificial intelligence model and assessing the leftover ingredient with the mapping algorithm of the recipe submodule to recommend recipes containing the leftover ingredient and/or the food ingredient. The method may involve integrating a recipe feedback mechanism within the electronic device to collect user feedback and/or social media feedback regarding the quality of the recipe recommendations. The user feedback and/or social media feedback may be analyzed by an interactive submodule using the processor to create a chef rating. The user feedback and/or social media feedback may be analyzed using the processor to enhance the accuracy of the mapping algorithm within the recipe submodule to refine the recipe recommendation generation by the recipe submodule.

In yet another aspect, an automated food recognition system includes a memory and a processor communicatively coupled to the memory. The processor executes instructions stored in the memory to intake a digital media from an electronic device using a camera and/or a file upload. The digital media is an image, a photograph, and/or an audiovisual media. The automated food recognition platform determines the presence of a food ingredient within the digital media by analyzing the digital media with an artificial intelligence model. The artificial intelligence model is trained using an edible food database, which contains a curated set of visual characteristics and/or identifying features for various food items. The edible food database is designed to train the artificial intelligence model to accurately recognize and/or identify food items from the digital media. The edible food database distinguishes between a locally sourced food ingredient and an imported ingredient based on the geographical location of the user. The automated food recognition platform automatically identifies at least one attribute of the food ingredient using a food information submodule. The attribute is a source of origin, a taste profile, a nutritional content, a food component, and/or a cooking method of the food ingredient. The automated food recognition platform automatically informs the user via the electronic device of at least one allergic quality of the food ingredient using an allergy submodule within the food information submodule. Additionally, the automated food recognition platform automatically informs the user via the electronic device of at least one attribute that interacts with at least one drug component.

The automated food recognition platform automatically generates a plurality of recommended recipes with a recipe submodule, where the recipe submodule is communicatively coupled to a recipe database and/or the food identification module. The recipe database is stored as nonvolatile memory. The recipe submodule receives outputs from the food identification module and/or the food information submodule and compares these outputs with a plurality of recipes listed in the recipe database using a mapping algorithm. The recipe submodule generates the plurality of recommended recipes for a user of the electronic device based on the outputs of the mapping algorithm. The recipes within the plurality of recommended recipes contain the food ingredients. The recipes within the plurality of recommended recipes contain a complementary item that is combined with the food ingredient during food preparation. The recipe submodule considers a dietary preference, a food restriction, and/or a cooking skill level of the user when generating the plurality of recommended recipes.

The automated food recognition platform assesses an inventory level of complementary item and/or the food ingredient at a vendor via a marketplace submodule and communicates the inventory level to the electronic device. The vendor communicates the inventory level of the food ingredient and/or the complementary item to the marketplace submodule over the network. An inventory level database processes information from the vendor to update their inventory levels of the food ingredient and/or the complementary item within the marketplace submodule. The inventory levels of the food ingredient and/or the complementary item are viewable to the user on the electronic device. The inventory level of the food ingredient and/or the inventory level of the complementary item for the vendor within the marketplace is input into the mapping algorithm of the recipe submodule and/or used to refine the plurality of recommended recipes.

The automated food recognition platform identifies at least one leftover ingredient from the digital media using a leftover identification submodule of the artificial intelligence model. The leftover ingredient is input to the mapping algorithm of the recipe submodule, and/or the recipe submodule recommends the plurality of recipes based on the at least one leftover ingredient food and/or the food ingredient. The automated food recognition platform creates a meal plan using a meal planning submodule based on the plurality of recommended recipes and/or secondary recipes identified by the recipe submodule. The meal planning submodule communicates with the marketplace submodule and/or recommends meal plans based on an inventory level of the complementary item at the vendor within a particular geographical region. The automated food recognition platform facilitates interaction between a community of chefs and/or the users via an interactive submodule. The individual chefs within the community of chefs have a chef profile displaying a chef name, a photo, a biography, a recipe board, and/or a weblink. The individual chefs may use the interactive submodule to share a custom recipe to the recipe database and/or the chef profile associated with that individual chef.

The users may critique the custom recipe with user feedback. The user feedback is viewable on the chef profile associated with the custom recipe. The mapping algorithm of the recipe database incorporates the user feedback and/or social media feedback to refine the selection of the plurality of recommended recipes from the recipe submodule. The social media feedback is an automatically compiled dataset of comments about the custom recipe from a plurality of social media platforms. A chef rating is created from the user feedback and/or social media feedback, and the chef rating is viewable on the chef profile. The chefs promote their custom recipes on the interactive submodule using a paid advertising service within the interactive submodule. The chefs receive compensation based on the chef rating generated from recipe feedback and/or interactions. The interactions are a recommendation frequency and/or chef profile visits, and the recommendation frequency is the frequency which a chef's custom recipe is included in the plurality of recommended recipes output by the recipe submodule.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is an interaction view illustrating a communication path between a user(s) of an electronic device, a plurality of vendors, a plurality of chefs, and a processing system of an automated food recognition platform, according to one embodiment.

FIG. 2 is a schematic block diagram illustrating the automated food recognition platform of FIG. 1 to identify a food ingredient using a food identification module of an artificial intelligence module, according to one embodiment.

FIG. 3 is a schematic block diagram illustrating a leftover identification submodule of the automated food recognition platform of FIG. 1 to identify leftover ingredients from a digital media of an electronic device using the artificial intelligence model, according to one embodiment.

FIG. 4 is a schematic block diagram illustrating an information submodule of FIG. 2 of the automated food recognition platform of FIG. 1, to identify an attribute of the food ingredient and the leftover ingredient, according to one embodiment.

FIG. 5 is a schematic block diagram illustrating a marketplace submodule of the automated food recognition platform of FIG. 1 to identify an inventory level of a complementary item and/or the food ingredient at a vendor(s), according to one embodiment.

FIG. 6 is a schematic block diagram illustrating a recipe submodule of the automated food recognition platform of FIG. 1 to recommend one or more recipes based on the leftover ingredient of FIG. 3 and/or the food ingredient of FIG. 2, according to one embodiment.

FIG. 7 is a schematic block diagram illustrating a meal planning submodule of the automated food recognition platform of FIG. 1 to create a meal plan based on recommended recipe(s) and/or one or more secondary recipes identified by the recipe submodule of FIG. 6, according to one embodiment.

FIG. 8 is a schematic block diagram illustrating an interactive submodule of the automated food recognition platform of FIG. 1 to facilitate interaction between a community of chefs and the users of FIG. 1, according to one embodiment.

FIG. 9 is a schematic block diagram illustrating an allergy submodule of the automated food recognition platform of FIG. 1 to automatically identify and inform the user via the electronic device of at least one allergic quality of the food ingredient, according to one embodiment.

FIG. 10 is a schematic block diagram illustrating a drug interaction submodule of the automated food recognition platform of FIG. 1 to identify and inform the user via the electronic device of at least one attribute that interacts with at least one drug component, according to one embodiment.

FIG. 11 is a representative view of the automated food recognition platform to recognize food items using artificial intelligence of FIGS. 1-10, according to one embodiment.

FIG. 12A is a user interface view of the electronic device of the user displaying the food ingredient using the food identification module, according to one embodiment.

FIG. 12B is a user interface view of a chef profile of the automated food recognition platform executed on the electronic device of the user of FIGS. 1, according to one embodiment.

FIGS. 13A and 13B are process flow diagrams depicting the automated food recognition platform to recognize food items using artificial intelligence, according to one embodiment of FIGS. 1-10.

Other features of the present embodiments will be apparent from the accompanying drawings and from the detailed description that follows.

### DETAILED DESCRIPTION

Example embodiments, as described below, may be used to provide an automated platform, method, and system for recognizing food items using artificial intelligence and providing recipe recommendations and dietary management based on the identified food items.

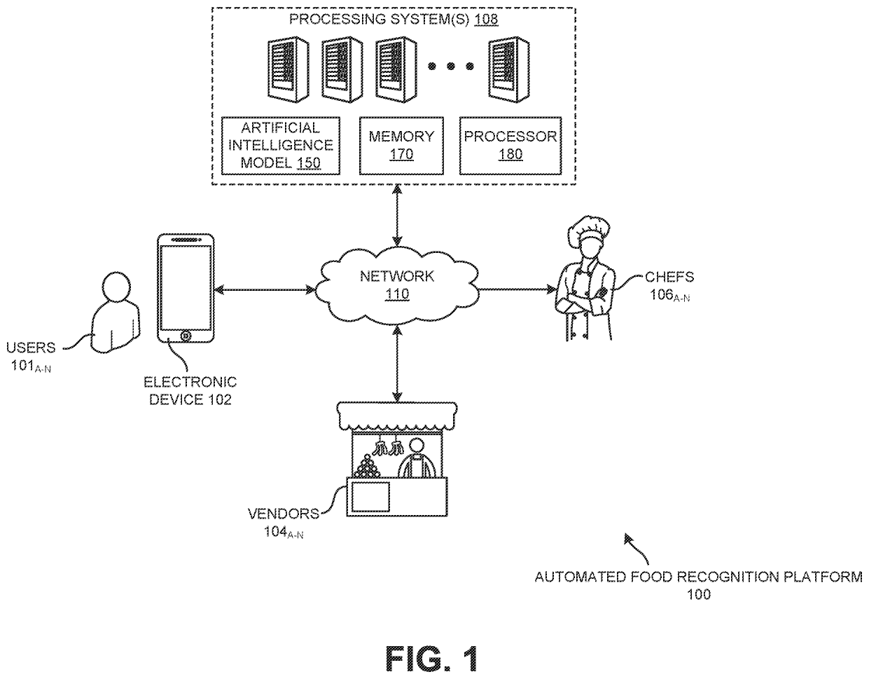

FIG. 1 is an interaction view illustrating a communication path between a user(s) 101A-N of an electronic device 102, a plurality of vendors 104A-N, a plurality of chefs 106A-N, and a processing system 108, according to one embodiment. FIG. 1 shows a automated food recognition platform 100, a plurality of users 101A-N, an electronic device 102, a plurality of vendors 104A-N, a plurality of chefs 106A-N, a processing system 108, an artificial intelligence model 150, a memory 170, a processor 180, and a network 110.

The automated food recognition platform 100 may be a system that may integrate artificial intelligence algorithms with digital imaging techniques and/or comprehensive database management systems. The automated food recognition platform 100 may accurately recognize, categorize, and/or analyze various food items from a broad spectrum of digital media 204 inputs. The automated food recognition platform 100 may process digital media 204 provided by the plurality of users 101A-N, extracting visual and/or textual information about the food items depicted. The automated food recognition platform 100 may comprise artificial intelligence (AI) capabilities which may enable the automated food recognition platform 100 to identify food items, understand their components, and/or supply nutritional information, allergen information, origin information, and/or potential recipes. The automated food recognition platform 100 may be built to cater to a wide range of the users 101A-N, from culinary professionals to everyday consumers, by providing valuable insights into the food items they encounter in their daily lives.

The plurality of users 101A-N may be individuals or entities, including but not limited to home cooks, professional chefs, dieticians, food enthusiasts, nutritionists, and/or culinary students, who may utilize the automated food recognition platform 100 for purposes including but not limited to meal planning, dietary tracking, culinary exploration, and/or educational purposes. The electronic device 102 may be a range of digital tools including but not limited to smartphones, tablets, digital cameras, computers, and/or smart home devices equipped with cameras and/or internet connectivity, which may be used to capture and/or transmit images and/or other digital media 204 of food items to the automated food recognition platform 100. The plurality of vendors 104A-N may be various online and/or offline food-related markets that facilitate the exchange of goods between buyers and vendors, including but not limited to grocery stores, farmers markets, online food delivery services, and/or specialty food shops, where the users 101A-N can purchase and/or learn about food items.

The plurality of chefs 106A-N may be professional cooks, culinary experts, home cooking enthusiasts, cooking show hosts, food bloggers, and/or culinary instructors who create and/or share recipes, cooking techniques, and/or food-related content. The processing system 108 may be a set of interconnected components and/or subsystems that may work together to perform operations on input data and produce output. The processing system 108 may encompass the processor 180, the memory 170, and/or the artificial intelligence model 150 which may collectively handle data in different stages, including but not limited to input, processing, storage, and/or output. The processing system 108 may be a set of computational procedures and/or algorithms designed to analyze and/or interpret data related to food items.

The artificial intelligence model 150 may be a mathematical and/or computational framework that may perform tasks and/or solve problems. The artificial intelligence model 150 may be trained on various forms of data which may allow the artificial intelligence model 150 to learn patterns, relationships, and/or representations that may enable it to make predictions, classifications, and/or generate responses in new and/or unseen situations. The artificial intelligence model 150 may be equipped with machine learning algorithms, image recognition technology, databases, and/or recipe matching capabilities, which may be designed to analyze and/or interpret food item data. The artificial intelligence model 150 may include the food identification module 200 which may analyze the digital media 204 transmitted by the electronic device 102, and/or may identify the food ingredient 214 within the digital media 204.

The network 110 may be a system of interconnected digital infrastructures, including but not limited to the internet, cloud computing services, data centers, and/or mobile networks, which may facilitate communication and/or data exchange between the automated food recognition platform 100, the users 101A-N, the electronic device 102, and/or other components of the automated food recognition platform 100. The memory 170 may be an electronic storage system used to store and/or retrieve data. The memory 170 may have the ability to store, retrieve, and/or adapt information about various food items based on previous experiences. The processor 180 may be a central component and/or module within the automated food recognition platform 100 that may be responsible for analyzing and/or identifying information related to food items in images, videos and/or other digital media 204. The processor 180 may perform various tasks, including but not limited to image processing, feature extraction, and/or pattern recognition.

As shown in FIG. 1, one or more users 101A-N, chefs 106A-N, processing systems 108, and/or vendors 104A-N may communicate with each other over the network 110. This communication may be over a wireless network and/or a wired network. The processing system 108 may comprise the artificial intelligence model 150, the memory 170, and the processor 180. The electronic device 102 may transmit a digital media 204 (not shown) to a food identification module 200 (not shown) via the network 110.

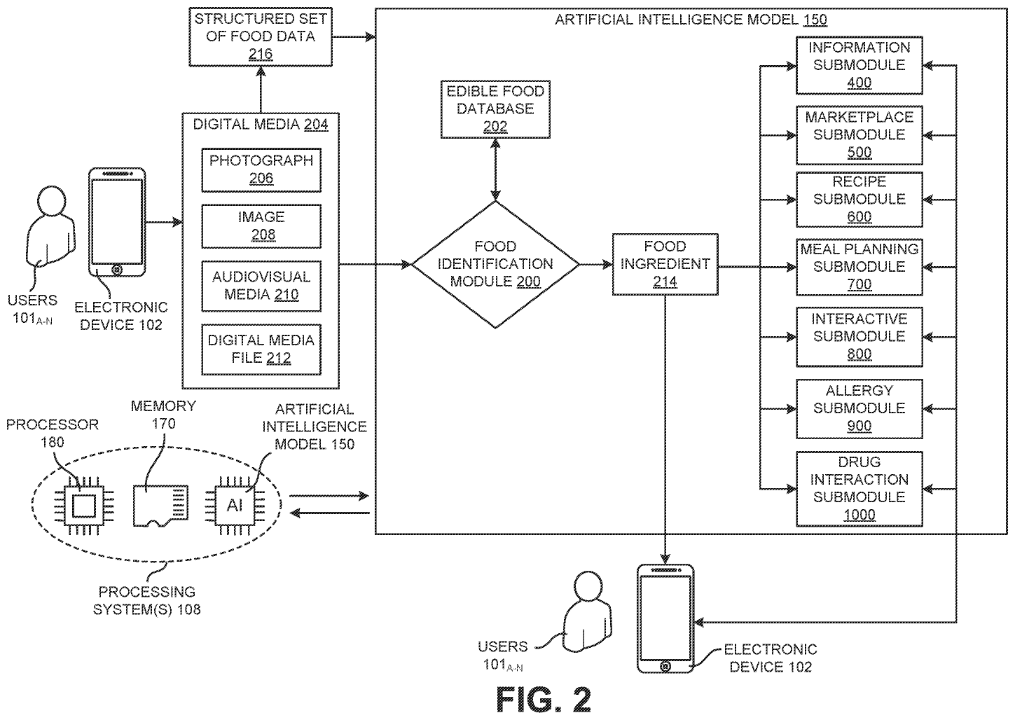

FIG. 2 is a schematic block diagram illustrating an artificial intelligence model 150 of the automated food recognition platform 100 of FIG. 1 comprising a food identification module 200 which may identify a food ingredient 214 from a digital media 204 received from an electronic device 102, according to one embodiment. FIG. 2 shows the users 101A-N, the electronic device 102, the processing system 108, the artificial intelligence model 150, the memory 170, the processor 180, the food identification module 200, an edible food database 202, a digital media 204, a photograph 206, an image 208, an audiovisual media 210, a digital media file 212, a food ingredient 214, a structured set of food data 216, an information submodule 400, a marketplace submodule 500, a recipe submodule 600, a meal planning submodule 700, an interactive submodule 800, an allergy submodule 900, and a drug interaction submodule 1000.

The food identification module 200 may discern and/or pinpoint specific food items and/or ingredients within various forms of digital media 204. The food identification module 200 may be equipped with image recognition and/or analysis algorithms, which may be capable of processing visual data. These algorithms may detect subtle nuances in food textures, colors, and/or shapes, which may enable the platform to accurately identify a wide range of ingredients. The edible food database 202 may be an organized collection of structured food information and/or food data, which may be received by the electronic device 102 from outside repositories in the form of the digital media 204 and/or may be organized and/or stored on the memory 170 as nonvolatile memory.

The digital media 204 may be content that is created, distributed, and/or consumed using digital technologies and may be stored in various digital formats. The digital media 204 may include the photograph 206, the image 208, and/or the audiovisual media 210. The digital media file 212 may be a file that stores multimedia data, including but not limited to audio, video, images, and/or text. The digital media file 212 may be created, edited, and/or accessed using the electronic device 102. The digital media file 212 may come in various formats which may be designed for specific types of content and/or applications.

The food ingredient 214 may be any substance and/or food components that may be combined to create a recipe and/or formula for a particular food item. The food ingredient 214 may be of plant and/or animal origin and may include items including but not limited to fruits, vegetables, grains, meats, dairy products, herbs, spices, sweeteners, fats, and/or other micro and/or macro components. The structured set of food data 216 may be organized food information that follows a specific format and/or arrangement, making the information/data easier to store, manage, and/or retrieve. The structured set of food data 216 may impose a meaningful order on the food data through a set of rules, conventions, and/or relationships. The structured set of food data 216 may be structured in a manner that may be used to train the artificial intelligence model 150.

The information submodule 400 may be a section within the automated food recognition platform 100 that may be designed to aggregate and/or exhibit extensive details on various food items and/or food ingredients 214. The information submodule 400 may provide nutritional content information including but not limited to calorie counts and/or micronutrient compositions which may aid in dietary management. The information submodule 400 may also encompass information about the origins of different food items which may offer insights into their geographical and/or cultural backgrounds. Furthermore, the information submodule 400 may elucidate the culinary uses of each food ingredient 214, showcasing traditional and/or modern cooking applications and/or suggesting potential recipe integrations.

The marketplace submodule 500 may connect the users 101A-N to various food-related marketplaces and/or vendors 104A-N and may incorporate real-time inventory levels 502 of the marketplaces and/or vendors 104A-N. The inventory levels 502 may serve as data reflecting the present availability of food ingredients 214 stored in the inventory level database 504. The inventory level database 504 may function as a structured repository responsible for storing and/or updating the inventory levels 502 of different food items across vendors 104A-N which may ensure users 101A-N have access to accurate and/or current stock information. The marketplace submodule 500 may allow the users 101A-N to purchase ingredients, find suppliers, and/or explore new food products with the added convenience of viewing current stock availability. The marketplace submodule 500 may predict the availability of the food ingredient 214 which is currently unavailable at the vendors 104A-N. The marketplace submodule 500 may display inventory data that may be provided by the vendors 104A-N including but not limited to quantities available and/or expected restock dates which may enhance user's 101A-N shopping experience by providing timely and/or relevant information. The marketplace submodule 500 may be particularly useful for the users 101A-N seeking specific and/or hard-to-find ingredients and may enable the user's 1041-N to efficiently locate these items across different vendors 104A-N.

The recipe submodule 600 may be a tool in the automated food recognition platform 100 that may offer dynamic recipe suggestions and/or creations. The recipe submodule 600 may leverage the food ingredient 214 from the user's 101A-N input of the digital media 204, dietary preferences 610, and/or nutritional requirements, as well as factor in the availability of ingredients from various vendors 104A-N, which may indicated by the marketplace submodule 500. By integrating this data, the recipe submodule 600 may generate tailored recipe options that align with the user 101A-N needs while considering the real-time availability of food ingredients 214, thereby offering a seamless and/or personalized cooking experience.

The meal planning submodule 700 may aid users 101A-N in organizing and/or planning their meals. The meal planning submodule 700 may integrate several dietary aspects to ensure a user's 101 meals to meet their dietary guidelines and/or personal health goals. The meal planning submodule 700 may incorporate information from the food identification module 200, the leftover identification submodule 300, information submodule 400, the marketplace submodule 500, the recipe submodule 600, the interactive submodule 800, the allergy submodule 900, and/or the drug interaction submodule 1000.

The meal planning submodule 700 may incorporate information about ingredient availability data from the marketplace submodule 500 which may allow users 101A-N to plan meals based on what ingredients are currently available and/or in season. Additionally, the meal planning submodule 700 may adapt to user preferences, creating meal plans that align with individual tastes, dietary restrictions, and/or cooking abilities. The meal planning submodule 700 may incorporate information about allergic qualities of the food ingredient 214 from allergy submodule 900 to ensure that the meal planning submodule 700 is not recommending the meal plan 708 that contain any allergic food ingredient 214 which may be harmful to the user 101A-N.

The meal planning submodule 700 may communicate with the drug interaction submodule 1000 to verify that the meal plan 708 excludes any food ingredient 214 that may interact with a medication the user 101 is taking which may minimize potential harm to the user 101. The meal planning submodule 700 may utilize data from the interactive submodule 800, which may receive diverse inputs including but not limited to dietary preferences 610, food ingredients 214, and/or user feedback 808. This information may be used to create a customized meal plan 708 tailored to the specific preferences of the user 101A-N. The meal planning submodule 700 may communicate to the recipe submodule 600 to consider both of the recommended recipe(s) 606 and the secondary recipe(s) 608 when generating the meal plan 708 for the user 101A-N.

The interactive submodule 800 may be an interface for user 101A-N engagement within the automated food recognition platform 100. The interactive submodule 800 may allow users 101A-N to actively input data and in response, receive customized suggestions. The interactive submodule 800 may facilitate interactions with other features of the automated food recognition platform 100 including but not limited to accessing the recipe submodule 600 and/or meal planning submodule 700, and may integrate feedback mechanisms for continuous improvement of user experience. The interactive submodule 800 may aim to make navigation intuitive, fostering an interactive and/or personalized journey through the automated food recognition platform 100. Additionally, the interactive submodule 800 may provide the users 101A-N with the ability to explore and/or engage with the profiles of chefs 106A-N featured on the automated food recognition platform 100. The users 101A-N may access a dedicated section within the interactive submodule 800 to view chef profiles 802. This feature may enhance the overall user experience by adding a human touch to the platform 100, connecting users 101A-N with the chefs 106A-N. Within the chef profiles 802, users may be able to find detailed information about a chef's background including but not limited to culinary training, and/or their philosophy when it comes to creating delightful dishes. The users 101A-N may also discover featured recipes curated by the chefs 106A-N and the users 101A-N.

To further enhance user engagement, the interactive submodule 800 may incorporate a rating and/or feedback system. The users 101A-N may provide ratings and/or reviews for custom recipes 616 they have tried and/or share their thoughts on the overall dining experience. This may not only help other users 101A-N make informed choices but may also serve as valuable feedback for both the chefs 106A-N and/or the automated food platform platform 100 itself. The rating system may contribute to the continuous improvement of the automated food recognition platform 100 which may ensure that the suggested recipes align with users' preferences and expectations. Moreover, the interactive submodule 800 may allow users 101 to bookmark their favorite chefs 106 and recipes for easy access in the future.

The allergy submodule 900 may identify and/or manage information related to food allergies that the user 101A-N may have. The allergy submodule 900 may enhance the safety of the user 101 with food allergies by providing accurate and/or timely information about the presence of allergens and/or allergic qualities in food items. The allergy submodule 900 may contain an extensive database of known allergens, including but not limited to peanuts, tree nuts, milk, eggs, soy, wheat, fish, and/or shellfish. This information may serve as a reference for the platform to identify potential allergens in analyzed food items. The allergy submodule 900 may consider this information when analyzing food items and may provide alerts and/or recommendations based on the user's 101A-N specific allergens. The allergy submodule 900 may communicate to the recipe submodule 600 to provide information about allergic qualities of different food items to the recipe submodule 600 which may ensure that the recipe submodule 600 is not recommending recipes that may be harmful to the user 101.

The allergy submodule 900 may collaborate with the drug interaction submodule 1000 to determine whether the allergic qualities 901 of the food ingredient 214 may interact adversely with any medications the user 101 is currently taking and/or may consider in the future. The allergy submodule 900 may further communicate with the meal planning submodule 700 to ensure that any meal plans generated consider the identified allergic qualities 901 of the user 101. The allergy submodule 900 may ensure that the food ingredients 214 within the inventory levels 502 provided by the marketplace submodule 500 do not include any type of allergic qualities 901 which may be harmful to the user 101A-N.

The drug interaction submodule 1000 may identify and/or analyze potential interactions between drugs and/or food ingredients 214. The drug interaction submodule 1000 may combine information about food ingredients 214 and/or drug interactions to offer guidance on making informed dietary choices of the user 101 while taking medications. This integration may be valuable for the user 101 for managing chronic conditions and/or complex medication regimens. The drug interaction submodule 1000 may have access to a comprehensive database of drugs, including but not limited to information about their pharmacological properties, potential interactions, and/or recommended dietary guidelines.

This information may be crucial for assessing the impact of specific food ingredients 214 on the effectiveness and/or safety of medications. The drug interaction submodule 1000 may provide information of interactions between drugs, the food ingredient 214, the leftover ingredient 302, and/or the complementary item 506 to the recipe submodule 600 to evaluate recipe recommendation. The drug interaction submodule 1000 may communicate to the meal planning submodule 700 to confirm that the meal plan 708 omits any food ingredient 214 without a quality that might interact with a prescribed medication for the user 101 which may minimize potential harm to the user 101. The drug interaction submodule 1000 may collaborate with the allergy submodule 900 to determine whether the allergic qualities 901 of the food ingredient 214 may interact adversely with any medications the user 101 is currently taking and/or may consider in the future. The drug interaction submodule 1000 may be equipped with information about the user's 101 medication history and/or the allergic qualities 901 identified by the allergy submodule 900 and may evaluate potential risks and/or provide recommendations.

As shown in FIG. 2, the automated food recognition platform 100 may include the processing system 108 which may comprise the memory 170 the processor 180 and/or the artificial intelligence model 150. The processor 180 may execute instructions stored in the memory 170 and/or may execute the artificial intelligence model 150. The user 101 may transfer the digital media 204 to the food identification module 200 of the artificial intelligence model 150 via the network 110. The electronic device 102 may transmit the digital media 204 to the food identification module 200 of the artificial intelligence model 150 via the network 110. The digital media 204 may be a digital media file 212, an image 208, a photograph 206, and/or an audiovisual media 210.

The digital media 204 may be processed by the food identification model 200 of the artificial intelligence model 150. The food identification model 200 may transmit the digital media 204 and/or the food ingredient 214 to the edible food database 202 where it may be stored as a nonvolatile memory. The edible food database 202 may be used to train the artificial intelligence model 150. The edible food database 202 may also transform the digital media 204 and/or information regarding the food ingredient 214 to a structured set of food data 216. The structured set of food data 216 may be used to train the artificial intelligence model 150. The edible food database 202 may be stored on the memory 170 as a nonvolatile memory.

The food identification module 200 may transmit the food ingredient 214 information to the user 101 (via the electronic device 102), the information submodule 400, the marketplace submodule 500, the recipe submodule 600, the meal planning submodule 700, the interactive submodule 800, the allergy submodule 900, and the drug interaction submodule 1000. Each of these submodules may communicate with the user 101 via the electronic device 102. The user 101 may communicate with the various modules within the artificial intelligence model 150.

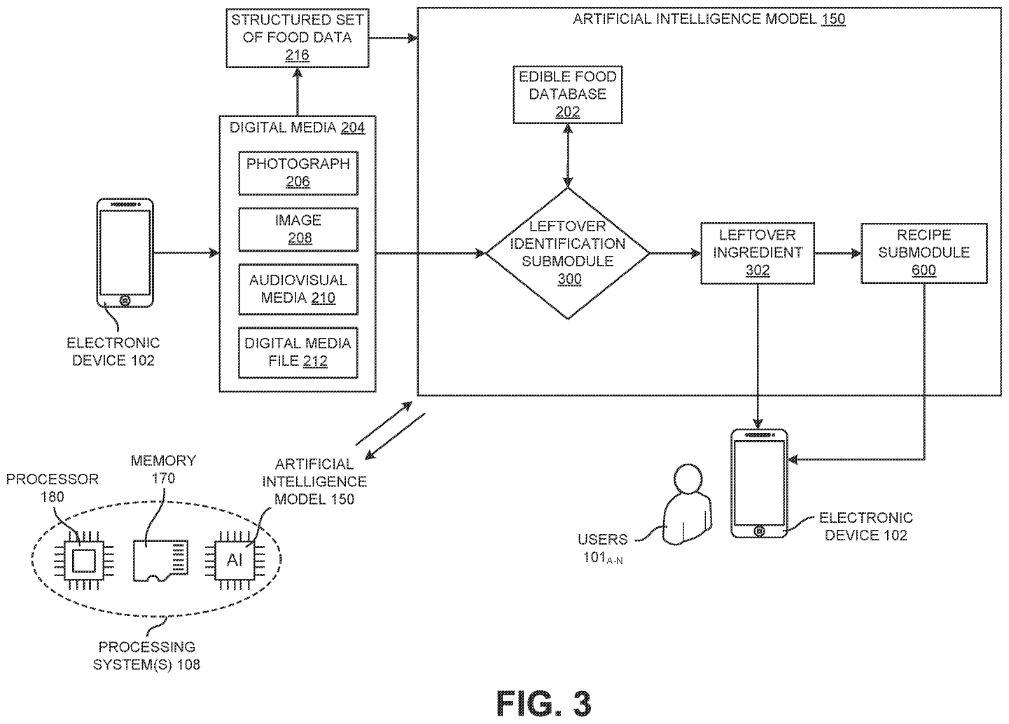

The leftover identification submodule 300 may identify a leftover ingredient 302 within a digital media 204, according to one embodiment. FIG. 3 shows the plurality of users 101A-N, the electronic device 102, the processing system 108 comprising the artificial intelligence model 150, the memory 170, and the processor 180, the edible food database 202, the digital media 204, the photograph 206, the image 208, the audiovisual media 210, the digital media file 212, the structured set of food data 216, a leftover ingredient 302, and the recipe submodule 600. The leftover ingredient 302 may be remaining portions of a meal that were not consumed, eaten, and/or thrown away during and/or after the initial serving. The leftover ingredient 302 may include any type of food, including but not limited to cooked dishes, fruits, vegetables, and/or snacks. The leftover ingredient 302 may be uneaten portions of meals and/or unused ingredients from a kitchen, cooler, freezer, refrigerator, pantry, and/or other food storage area that may be identified by automated food recognition platform 100 for potential reuse in creating new recipes and/or meal plans.

As shown in FIG. 3, the artificial intelligence model 150 may comprise the leftover identification submodule 300 which may identify at least one leftover ingredient 302 from the digital media 204. The user 101 may transfer the digital media 204 from and/or with the electronic device 102 to the leftover identification submodule 300 of the artificial intelligence model 150 via the network 110. The digital media 204 may be a digital media file 212, an image 208, a photograph 206, and/or an audiovisual media 210.

The digital media 204 may be processed by the leftover identification submodule 300. The leftover identification submodule 300 may analyze the digital media 204 transmitted by the electronic device 102, and may identify the leftover ingredient 302 within the digital media 204. The leftover identification submodule 300 may transmit the leftover ingredient 302 information to the user 101 via the electronic device 102 over the network 110. The leftover ingredient 302 may be input to the mapping algorithm 604 (not shown) of the recipe submodule 600. The recipe submodule 600 may produce a one or more recommended recipe 606 (not shown) and/or a one or more secondary recipe 608 (not shown) based on at least one of the leftover ingredient 302 and/or the food ingredient 214.

The leftover identification submodule 300 may transfer the digital media 204 and/or the leftover ingredient 302 to the edible food database 202 where it may be stored. The edible food database 202 may be used to train the artificial intelligence model 150. The edible food database 202 may also transform the digital media 204 and/or information regarding the leftover ingredient 302 to the structured set of food data 216 (e.g. the structured set of food data 216 may be formed from the digital media 204 and may then be stored within the edible food database 202). The artificial intelligence model 150 may be trained using the structured set of food data 216. The edible food database 202 may be stored on the memory 170 as a nonvolatile memory.

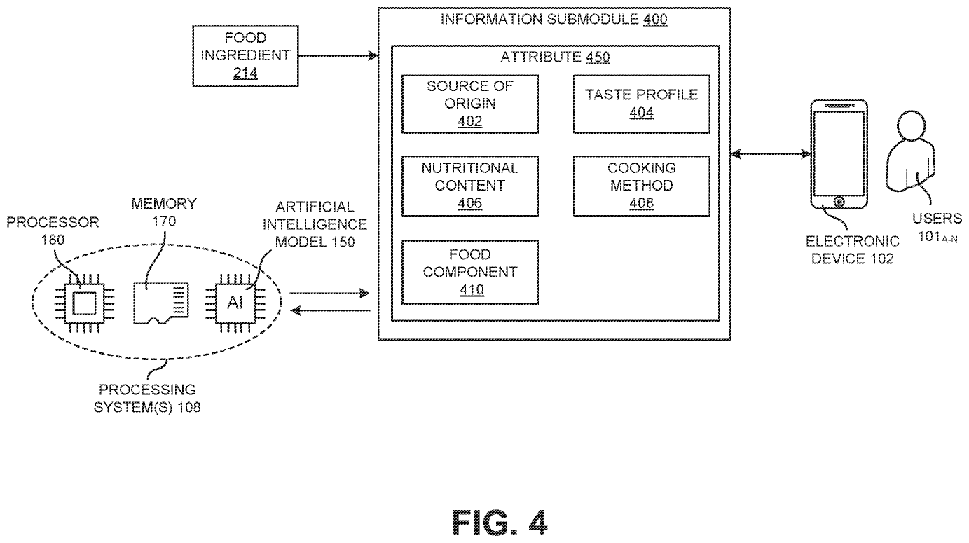

FIG. 4 is a schematic block diagram illustrating the information submodule 400 of FIG. 2 of the automated food recognition platform 100 of FIG. 1. The information submodule 400 may identify an attribute 450 of the food ingredient 214 and/or the leftover ingredient 302, according to one embodiment. FIG. 4 shows the users 101A-N, the electronic device 102, the processing system 108 comprising the artificial intelligence model 150, the memory 170, and the processor 180, the users 101A-N, the electronic device 102, the food ingredient 214, the information submodule 400, a source of origin 402, a taste profile 404, a nutritional content 406, a cooking method 408, a food component 410, and an attribute 450.

The source of origin 402 may be a feature that details the geographical and/or cultural background of the food ingredient 214 and/or the leftover ingredient 302, which may provide the users 101A-N with information about where the ingredient is/can be grown and/or produced. The taste profile 404 may be an analytical component that describes the flavor characteristics of the food ingredient 214 and/or the leftover ingredient 302, including but not limited to sweet, salty, umami, and/or spicy, which may aid the users 101A-N in understanding and/or choosing ingredients. The nutritional content 406 may be a comprehensive breakdown of the macro and/or micronutrient values of food items, including but not limited to calories, fats, proteins, carbohydrates, vitamins, and/or minerals. The cooking method 408 may be a detailed guide on various ways to prepare and/or cook the food ingredient 214 and/or the leftover ingredient 302. The food component 410 may be a specific substance and/or nutrient present in the food ingredient 214 and/or the leftover ingredient 302 that may contribute to its composition. The attribute 450 may be various characteristics and/or qualities of the food ingredient 214 that describe its sensory, nutritional, and/or other properties. The attributes 450 may include the source of origin 402, the taste profile 404, the nutritional content 406, the food component 410, and/or the cooking method 408 of the food ingredient 214.

As shown in FIG. 4, the information submodule 400 of the artificial intelligence model 150 may automatically identify an attribute 450 of the food ingredient 214. The attribute 450 may be a source of origin 402, a taste profile 404, a nutritional content 406, a food component 410, and/or a cooking method 408 of the food ingredient 214. After identifying the attribute 450, the information submodule 400 may transmit information regarding the attribute 450 to the electronic device 102 of the user 101 via the network 110.

Upon determining the attribute 450, the information submodule 400 may transfer the attribute 450 information to the user 101 of the electronic device 102. The electronic device 102 may present the attribute 450 in an organized manner which may allow the user 101 to comprehend and/or utilize the information. The electronic device 102 may allow the user 101 to browse through the information submodule 400 of the automated food recognition platform 100 which may allow the user 101 to see details including but not limited to the food ingredient's 214 source of origin 402, taste profile 404, nutritional content 406, food component 410, and/or cooking method 408.

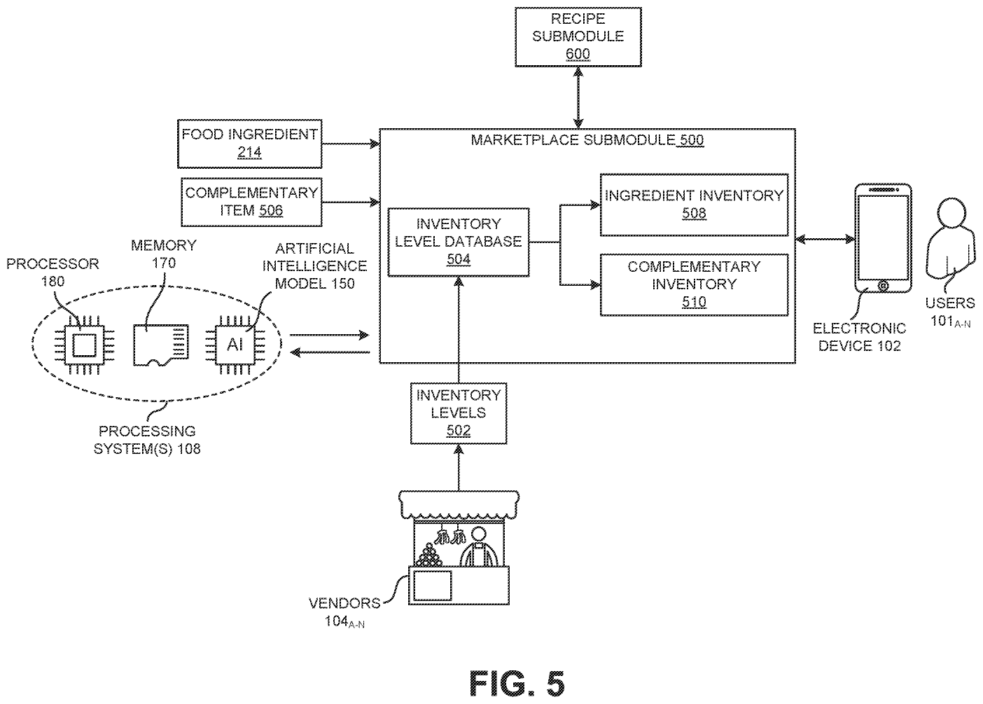

FIG. 5 is a schematic block diagram illustrating a marketplace submodule of the automated food recognition platform of FIG. 1, to identify an inventory level 502 of a complementary item 506 and/or the food ingredient 214 at a vendor, according to one embodiment. FIG. 5 shows the users 101A-N, the electronic device 102, the vendors 104A-N, the processing system 108 comprising the artificial intelligence model 150, the memory 170, and the processor 180, the food ingredient 214, an inventory levels 502, an inventory level database 504, a complementary item 506, an ingredient inventory 508, and a complementary inventory 510.

The inventory levels 502 may be data indicating the current stock availability of various food ingredients and/or ingredients at different vendors 104A-N. The vendors 104A-N may communicate their inventory levels 502 of various goods and/or food items with the marketplace submodule 500. The inventory level database 504 may be an organized repository storing and/or updating the inventory levels 502 of the various food items at vendors 104A-N which may ensure users 101A-N have access to accurate and/or current stock information. The complementary item 506 may be additional food items and/or ingredients suggested to the users 101A-N, which pair and/or be in recipes that may also contain the food ingredient 214.

The ingredient inventory 508 may be a specific segment of the inventory level database 504 that may show the availability and/or quantity of individual items at the vendors 104A-N. The complementary inventory 510 may be a dedicated section of the inventory level database 510 that may focus on the availability and/or quantity of complementary items 506 at the vendors 104AN-N.

As shown in FIG. 5, the marketplace submodule 500 may identify an inventory level 502 of the complementary item 506 and/or the food ingredient 214 at a vendor 104A-N. The vendor 104A-N may communicate the inventory level 502 of the food ingredient 214 and the complementary item 506 to the marketplace submodule 500 over the network 110. The inventory level 502 of the food ingredient 214 and the complementary item 506 may be communicated to the user 101 via the electronic device 102. The inventory level database 504 may collect and/or process information from the plurality of vendors 104A-N to update their inventory levels 502 of the food ingredient 214 and/or the complementary item 506 within the inventory level database 504 within the marketplace submodule 500. The inventory levels 502 of the food ingredient 214 and/or the complementary item 506 may be viewable to the user 100 on the electronic device 102. The inventory level 502 of the food ingredient 214 and/or the inventory level 502 of the complementary item 506 for the vendors 104A-N within the marketplace may be input into the mapping algorithm 604 of the recipe submodule 600 and used to refine selecting the recommended recipe(s) 606 further.

The complementary item 506 may be part of the recommended recipe(s) 606, enhancing the user's 101A-N culinary experience by suggesting items that complement their primary selections. The mapping algorithm 604 of the recipe submodule 600 may utilize the real-time inventory levels 502 of both the food ingredient 214 and the complementary item 506 across various vendors 104A-N within the marketplace submodule 500. This data may be used to refine selecting the recommended recipe(s) 606 by ensuring that the recommended recipe(s) 606 align with the current availability of the food ingredient 214 and the complementary item 506.

The mapping algorithm 604 may analyze the inventory levels 502 and prioritize recommending recipes that may be easily prepared based on the inventory levels 502 of the food ingredient 214 and/or complementary item 506. By incorporating the complementary inventory 506 into the mapping algorithm 604, the automated food recognition platform 100 may ensure that the users 101 receive comprehensive and/or harmonious recipe recommendations that go beyond the food ingredient 214.

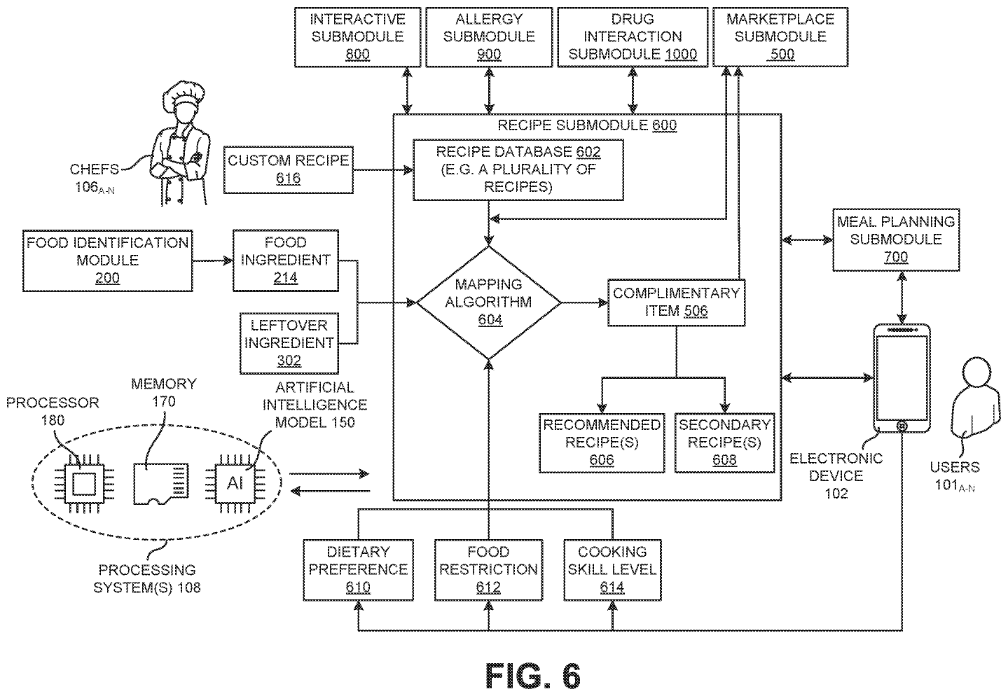

FIG. 6 is a schematic block diagram illustrating a recipe submodule 600 of the automated food recognition platform 100 of FIG. 1. The recipe submodule 600 may generate one or more recipes based on the food ingredient 214 and the leftover ingredient 302, according to one embodiment. FIG. 6 shows the users 101A-N, the electronic device 102, the chiefs 106A-N, the processing system 108 comprising the artificial intelligence model 150, the memory 170, and the processor 180, the food ingredient 214, the leftover ingredient 302, the complementary item 506, the recipe submodule 600, a recipe database 602, a mapping algorithm 604, a recommended recipe(s) 606, a secondary recipe(s) 608, a dietary preference 610, a food restriction 612, a cooking skill level 614, a custom recipe 616, the meal planning submodule 700, the interactive submodule 800, the allergy submodule 900, and the drug interaction submodule 1000.

The recipe database 602 may be a repository of recipes which may be enriched by contributions from the plurality of chefs 106A-N. The mapping algorithm 604 may be an artificial intelligence system that may be designed to analyze a range of user 101 inputs within the automated food recognition platform 100. The mapping algorithm 604 may assess the food ingredient 214, the leftover ingredient 302 and/or the complimentary item 506 in conjunction with the marketplace submodule 500, the allergy submodule 900, and/or the drug interaction submodule 1000 to find one or more recommended recipes 606 and/or one or more secondary recipes 608 within the recipe database 602. The mapping algorithm 604 may further employ machine learning techniques to understand complex culinary relationships and/or preferences. The mapping algorithm 604 may identify subtle nuances in flavor combinations, nutritional balancing, and/or recipe complexity. This may enable the mapping algorithm 604 to provide the users 101A-N highly personalized, relevant, and/or achievable recipe suggestions from the recipe database 602.

The recommended recipe(s) 606 may be one or more recipes curated by the mapping algorithm 604, offering selections that may be deemed most suitable for each user 101. This process may involve analyzing the user 101A-N inputs, including but not limited to available ingredients, dietary needs, and/or cooking proficiency. The secondary recipe(s) 608 may be one or more alternative recipe suggestions that are not fully aligned with the user's 101 primary preferences and/or needs but still may offer valuable culinary options. The secondary recipe(s) 608 generated by the mapping algorithm 604, may slightly deviate from the user's specific dietary preferences (dietary preference 610) and/or available ingredients communicated by the marketplace submodule 500. The complementary item 506 may be part of the recommended recipe(s) 606 and secondary recipe(s) 608. The complementary item 506 may serve as an additional element that enhances the overall cooking experience for the user 101. The complementary item 506 may be an ingredient, seasoning, and/or accompaniment that complements the main food ingredient 214 of the recommended recipe(s) 606 and/or the secondary recipe(s) 608. The mapping algorithm 604 may consider the flavor profiles and/or culinary synergies between the complementary item 506 and the selected recipes, ensuring a harmonious combination that appeals to the user's 101 taste preferences.

The dietary preference 610 may be the user's 101 choices and/or restrictions regarding the types of food they consume. The dietary preference 610 may encompass the user's 101A-N dietary habits, including the types of foods they prefer to eat, avoid, and/or limit. The dietary preference 610 may be influenced by various factors, including but not limited to cultural, religious, ethical, health, and/or personal beliefs. The integration of the dietary preference 610 into recipe submodule 600 may enable the system to deliver highly customized and/or pertinent information to the users 101A-N. This may improve the user 101A-N experience by presenting tailored suggestions, recipe ideas, and/or nutritional insights that align with individual and/or group dietary preferences 610.

The food restriction 612 may be a data input from the user 101 that may detail dietary restrictions and/or allergies. The food restriction 612 may be limitations and/or constraints imposed on the platform 100 by the user 101 in terms of identifying and/or categorizing certain types of food. This may involve restricting the system's ability to recognize specific dishes, ingredients, and/or dietary preferences based on user-defined criteria or pre-set guidelines by the users 101A-N. The cooking skill level 614 may be a feature allowing users 101A-N to indicate their level of culinary expertise which the system may use to suggest recipes that match their skill level. The mapping algorithm 604 may receive and/or analyze the dietary preference 610, the food restriction 612, the cooking skill level 614, and/or other user inputs.

The mapping algorithm 604 may use this information to ensure the recipe suggestions are safe and/or appropriate for their health requirements and/or cooking skills. The custom recipe 616 may be a personalized and/or unique set of instructions for preparing a particular dish and/or beverage as customized by a chef 106. The chefs 106A-N may input the custom recipe 616 into the recipe database 602 of the recipe submodule 600.

As shown in FIG. 6, the automated food recognition platform 100 may include a recipe database 602 stored on the memory 170 as nonvolatile memory. The recipe submodule 600 may be communicatively coupled to the recipe database 602 and/or the food identification module 200. The recipe submodule 600 may receive outputs from the food identification module 200 communicatively coupled to the food information submodule 400 and/or the leftover identification submodule 300 and compare the outputs of both submodules with a plurality of recipes listed in the recipe database 602 using a mapping algorithm 604. The recipe submodule 600 may generate one or more recommended recipe 606 for the user 101 of the electronic device 102 based on the outputs of the mapping algorithm 604. The recipes within the one or more recommended recipes 606 may contain the food ingredient 214, the leftover ingredient 302, and/or the complementary item 506.

The recipe submodule 600 may consider the dietary preference 610, the food restriction 612, and/or the cooking skill level 614 of the user 101A-N when generating the recommended recipe(s) 606. The recipe submodule 600 may further consider information from the interactive submodule 800 which may input various data including but not limited to dietary preferences 610, food ingredient 214, and/or user feedback 808 into the recipe submodule 600. The interactive submodule 800 may share a custom recipe 616 to the recipe database 602 and the chef profile 802 (not shown) associated with that individual chef 106A-N. The recipe submodule 600 may consider the allergy submodule 900 which may communicate allergic qualities of different food items to the recipe submodule 600 to ensure the recipe submodule 600 is not recommending recipes that may be harmful to the user 101.

The recipe submodule 600 may consider the drug interaction submodule 1000 to analyze potential interactions between drugs, the food ingredient 214, the leftover ingredient 302, and/or the complementary item 506. The recipe submodule 600 may communicate with the marketplace submodule 500 to identify the inventory level 502 of the complementary item 506 and/or the food ingredient 214 at a vendor 104A-N which the mapping algorithm 604 may consider when creating the recommended recipe(s) 606 and the secondary recipe(s) 608.

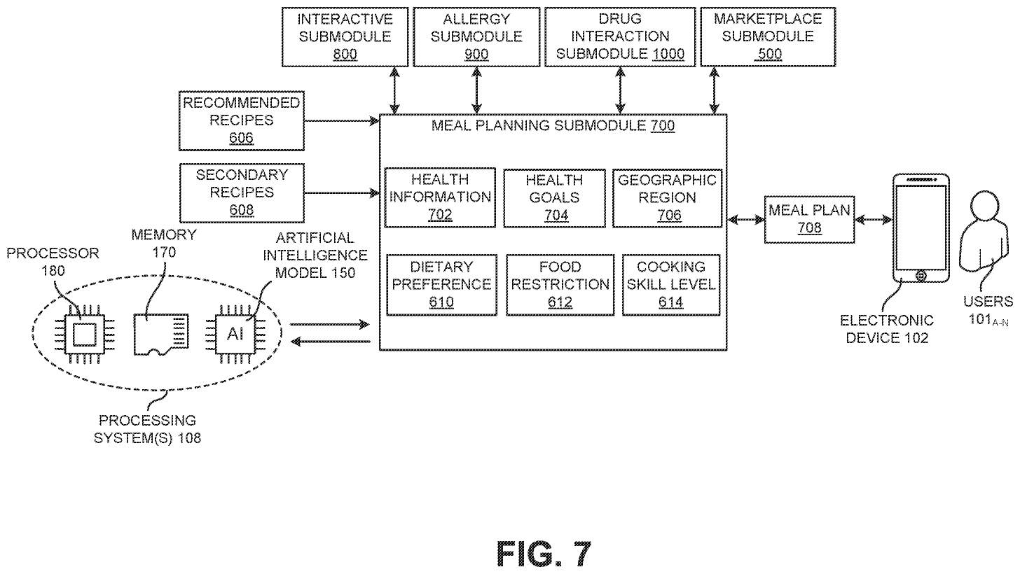

FIG. 7 is a schematic block diagram illustrating a meal planning submodule 700 of the automated food recognition platform of FIG. 1 to create a meal plan 708 based on recommended recipe(s) 606 and/or secondary recipe(s) 608 identified by the recipe submodule 600 of FIG. 6, according to one embodiment. FIG. 7 shows the users 101A-N, the electronic device 102, the processing system 108 comprising the artificial intelligence model 150, the memory 170, and the processor 180, the recommended recipe(s) 606, the secondary recipe(s) 608, the dietary preference 610, the food restriction 612, the cooking skill level 614, the meal planning submodule 700, a health information 702, a health goals 704, a geographic region 706, a meal plan 708, the interactive submodule 800, the allergy submodule 900, and the drug interaction submodule 1000.

The health information 702 may be a comprehensive aggregation of personal health data for users 101A-N, including metrics including but not limited to weight, heart rate, blood pressure, cholesterol levels, and/or blood sugar levels. The health information 702 may also encompass medical history details including but not limited to known illnesses, allergies, and/or chronic conditions, along with fitness-related data including but not limited to activity levels, exercise routines, and/or sleep patterns. This extensive information may aid in creating a holistic view of the user's 101A-N health, essential for tailoring meal and/or dietary plans to individual health goals and requirements.

The health goals 704 may be user-defined objectives related to their dietary and/or wellness aspirations, including but not limited to weight management, improving heart health, and/or maintaining balanced blood sugar levels. The geographic region 706 may be a specific geographical area and/or location of the user 101A-N. The geographical region 706 may be the specific area where these vendors 104A-N operate and/or provide their services. The automated food recognition platform 100 may take into account the inventory levels 502 of the food ingredient 214 and/or complementary items 506 within this particular geographic region 706 to generate the meal plan 708 recipes for the users 101A-N. The distinction between a locally sourced food ingredient 214 and/or an imported ingredient may be made by considering the geographical location 706 of the user 101A-N.

The meal plan 708 may be a systematic approach to organizing and/or structuring meals of the user 101A-N over a specific period of time. The meal planning submodule 700 may consider and/or interact with the marketplace submodule 500 to recommend the meal plans 708 which may be influenced by the inventory level 502 of the complementary items 506 available from a variety of the vendors 104A-N. The meal plan 708 may involve planning and/or pre-determining what the user 101A-N may eat. The meal plan 708 may be created based on the dietary preference 610, the food restriction 612, the health information 702, and/or the health goals 704 of the user 101A-N.

As shown in FIG. 7, the meal planning submodule 700 may allow the user 101A-N to create a meal plan 708 based on the recommended recipe(s) 606 and/or one or more secondary recipes 608 identified by the recipe submodule 600. The meal planning submodule 700 may communicate with the marketplace submodule 500 and recommend meal plans 708 based on the complementary inventory 510 and/or ingredient inventory 508 in the plurality of vendors 104A-N within a particular geographical region 706.

The meal planning submodule 700 may receive the recommended recipe(s) 606 and secondary recipe(s) 608 from the recipe submodule 600. Taking into account the user's 101 health information 702, health goals 704, geographic region 706, dietary preference 610, food restrictions 612, and cooking skill level 614, the meal planning submodule 700 may use the recommended recipe(s) 606 and/or the secondary recipe(s) 608 to create a meal plan 708 and transmit this meal plan 708 to the user's 101 via the electronic device 102. Furthermore, the meal planning submodule 700 may produce the meal plan 708 with input from the interactive submodule 800, the allergy submodule 900, and/or the drug interaction submodule 1000.

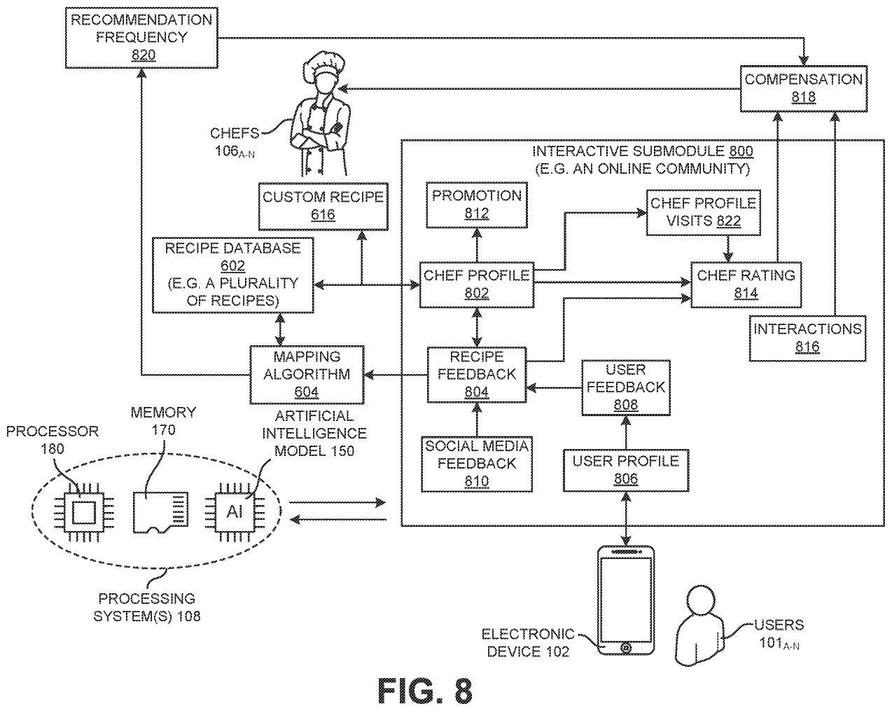

FIG. 8 is a schematic block diagram illustrating the interactive submodule 800 of the automated food recognition platform 100 of FIG. 1 to facilitate interaction between a community of chefs 106A-N and the users 101A-N of FIG. 1, according to one embodiment. FIG. 8 shows the users 101A-N, the electronic device 102, the chefs 106A-N the processing system 108 comprising the artificial intelligence model 150, the memory 170, and the processor 180, the recipe database 602, the mapping algorithm 604, the custom recipe 616, the interactive submodule 800, a chef profile 802, a recipe feedback 804, a user profile 806, a user feedback 808, a social media feedback 810, a promotion 812, a chef rating 814, an interactions 816, a compensation 818, a recommendation frequency 820, and a chef profile visits 822.

The chef profile 802 may be a social media-like account detailing a chef's 106 culinary expertise, experience in various cuisines, accolades, and/or personal cooking philosophy. The chef profile 802 may further serve as a personalized space where chefs 106A-N can showcase their skills, share information about their culinary background, and/or connect with users 101A-N and/or fellow chefs. A chef profile 802 may include various elements including but not limited to a chef name 1204, a photo 1202, a biography 1208, a recipe board 1206, and/or a weblink 1210 to provide a holistic view of the chef's 106 identity. The recipe feedback 804 may include numerical user 101 ratings, comments on taste and/or ease of preparation, and/or suggestions for improvement.

The recipe feedback 804 may be information, opinions, and/or evaluations provided by the users 101 and/or individuals who have experienced one or more custom recipe 616 and/or interaction with the chef 106. The recipe feedback 804 may include various aspects related to the preparation, taste, presentation, and/or overall experience of making and/or consuming the dish. The user profile 806 may encompass individual dietary preferences 610, cooking skills 614, favorite cuisines, and/or health goals 704. The user profile 806 may be a comprehensive digital representation of an individual user's preferences, behaviors, and/or interactions 816 within the platform 100. The user profile 806 may serve as a personalized space that captures key information about the user 101 including but not limited to the user's 101 name, location of residence, food preferences, biography and/or photo.

The user feedback 808 may be a combination of ratings, reviews, and/or suggestions about the the chef's 106 custom recipe 616. The user feedback 808, provided by users 101A-N, may additionally offer valuable insights into the automated food recognition platform 100. The user feedback 808 may be prominently displayed on the chef profile 802 which may allow chefs 106 to understand user preferences, receive constructive criticism, and/or make informed adjustments to enhance their recipes. The social media feedback 810 may involve users' shared experiences and/or opinions about a chef 106 and/or the custom recipe 616 as shared on social networks.

The promotion 812 may cover various marketing activities, including special recipe features and/or collaborations. The promotion 812 of the automated food recognition platform 100 may involve advertising and/or other interest generating activities that may encourage potential users 101 to download and/or use the application. Furthermore, the promotion 812 may be the chef's 106 personalized advertising of their recipes, cookbooks, digital media appearances, and/or other activities. The chef rating 814 may be an aggregated user feedback 808, social media feedback 810, recipe feedback 804, and/or chef profile visits 822. The chef rating 814 may further refer to an assessment and/or score assigned to the chef 106 based on the performance and/or accuracy of their dishes as recognized by the automated food recognition platform 100 using algorithms to identify and/or analyze various aspects of dishes, including but not limited to ingredients, presentation, and/or overall quality.

The interactions 816 may be an aggregate of user 101 social interactions with the chef 106 including but not limited to profile visits, comments, shares, reposts, retweets, recipe sharing, culinary discussions, and/or community engagements. The compensation 818 may involve various incentives like monetary rewards, recognition, and/or exclusive platform features for active participation. The compensation 818 may be calculated from the chef rating 814, the interactions 816, and/or the recommendation frequency 820. The recommendation frequency 820 may be the frequency that the chef's 106 custom recipe 616 is included in the recommended recipe(s) 606 output by the recipe submodule 600 and the recommendation frequency 820 may be used as a metric to calculate the compensation 818. The recommendation frequency 820 may not only serve as a quantitative measure of a custom recipe's 616 popularity but also influences the compensation 818 provided to the chef 106A-N. T

The chef profile visits 822 may be a factor considered for determining the compensation 818 for the individual chefs 106A-N. This may involve an aggregate number of visits to the chef's profile 802 and/or an impactful visit by someone who may be famous and/or may carry more esteem than an average user 101. The individual chefs 106A-N may receive compensation 818 based on the number of visits to their chef's profile 802. A higher number of chef profile visits 822 may be an indicator of the chef's 106A-N popularity and/or the appeal of their custom recipe 616. The more visits the chef's profile 802 receives, the more it may contribute to their overall rating 814 and potential compensation 818.

As shown in FIG. 8, the interactive submodule 800 may include an online community of a plurality of chefs 106A-N. The plurality of chefs 106A-N may be a group and/or network within the automated food recognition platform 100 that consists of multiple individual chefs where the chefs 106A-N may interact, share, and/or collaborate on culinary content. The individual chefs 106A-N within the community of chefs 106A-N may have a chef profile 802 displaying a chef name 1204, a photo 1202, a biography 1208, a recipe board 1206, and/or a weblink 1210. The individual chefs 106A-N may use the interactive submodule 800 to share a custom recipe 616 to the recipe database 602 and/or the chef profile 802 associated with that individual chef 106A-N. The recommendation frequency 820 may be the frequency that a chef's 106 custom recipe 616 is included in the recommended recipe(s) 606 output by the recipe submodule 600. The recommendation frequency 820 may be used as a metric to calculate the compensation 818. The recommendation frequency 820 may refer to how often a chef's 106 custom recipe 616 is included in the recommended recipe(s) 606 output by the recipe submodule 600. This metric may serve as a quantitative measure of a recipe's popularity among users 101A-N. The more frequently a chef's custom recipe 616 may appear in the recommendations, the higher the recommendation frequency 820 may be.

The users 101A-N may critique the custom recipe 616 with user feedback 808. The user feedback 808 may be viewable on the chef profile 802 associated with the custom recipe 616. The user feedback 808 may serve as a valuable resource for the chefs 106 and/or aspiring cooks alike. By delving into the nuances of the critiques, the chefs 106A-N may gain insights into the preferences and/or expectations of the user 101. This real-time exchange of information may empower the chefs 106A-N to make informed adjustments to their recipes which may ensure they resonate with a broader spectrum of tastes.

The mapping algorithm 604 of the recipe submodule 600 may incorporate the user feedback 808 and/or social media feedback 810 to refine the selection of recommended recipe(s) 606 from the recipe submodule 600. As the users 101 engage with the recommended recipe(s) 606, the automated food recognition platform 100 may gather valuable insights into individual preferences, cooking method 408, and/or food ingredient 240 preferences. This data may be integrated into the mapping algorithm 604, which may allow it to continuously evolve and/or provide more personalized and/or accurate recommendations over time. The social media feedback 810 may be an automatically compiled dataset of comments about the custom recipe 616 from a plurality of social media platforms. The social media feedback 810 may be the opinions, comments, and/or reviews shared by the users 101 about the custom recipe 616.

The chef rating 814 may be created from the user feedback 808 and/or social media feedback 810. The chef rating 814 may refer to an assessment and/or score assigned to the chef 106 based on the custom recipe 616. The chef rating 814 may be viewable on the chef profile 802. The chefs 106A-N may receive compensation 818 based on the chef rating 814 generated from recipe feedback 804 and/or interactions 816. The compensation 818 may be a multifaceted incentive structure, encompassing monetary rewards, recognition, and/or exclusive platform features. The recommendation frequency 820 may be used to determine the level of compensation 818 the chef 106 receives. Each visit to a chef profile 802 may signify user 101 engagement and interest in the culinary creations of a particular chef 106. These interactions 816 contribute to the overall evaluation of the chef's 106 popularity and influence within the platform 100.

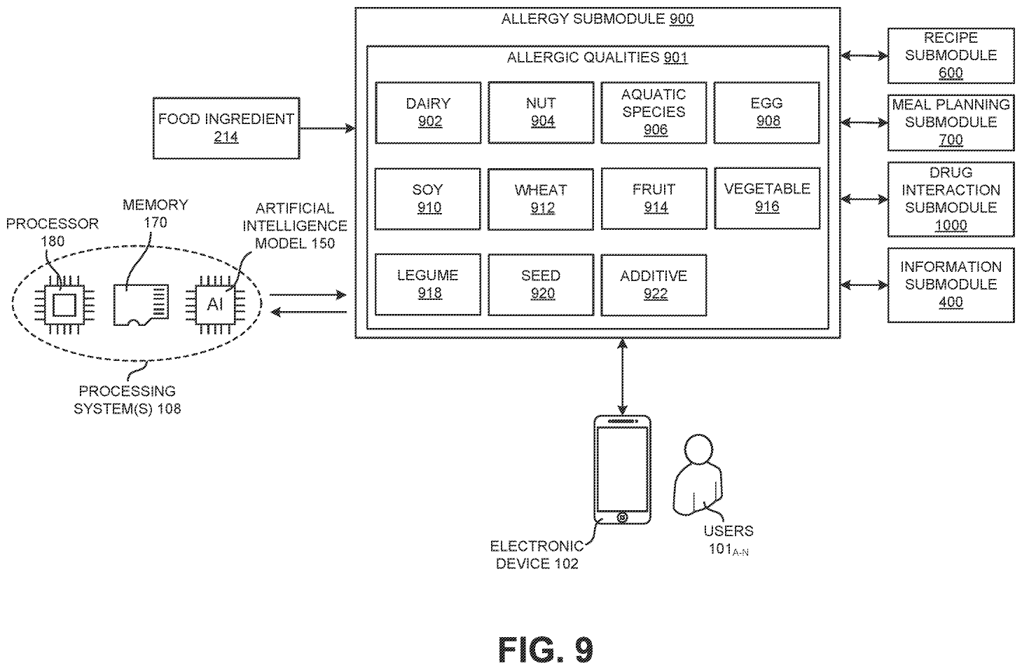

FIG. 9 is a schematic block diagram illustrating an allergy submodule 900 of the automated food recognition platform 100 of FIG. 1 to automatically identify and/or inform the user 101 via the electronic device 101 of at least one allergic quality of the food ingredient 214, according to one embodiment. FIG. 9 shows the user 101, the electronic device 102, the processing system 108 comprising the artificial intelligence model 150, the memory 170, and the processor 180, the food ingredient 214, the information submodule 400, the recipe submodule 600, the meal planning submodule 700, the allergy submodule 900, an allergic quality 901, a dairy 902, a nut 904, an aquatic species 906, an egg 908, a soy 910, a wheat 912, a fruit 914, a vegetable 916, a legume 918, a seed 920, an additive 922, and the drug interaction submodule 1000.

As shown in FIG. 9, allergic quality 901 may be a characteristic, component, and/or any quality that may make a food allergic to a user 101. The dairy 902 may be a category of food products that are derived from the milk of mammals, including but not limited to cows, goats, sheep, and/or other animals. The dairy 902 products may include a variety of foods, including but not limited to milk, cheese, butter, yogurt, and/or ice cream. The nut 904 may be a variety of edible seeds and/or fruits with a hard, outer shell and/or an inner kernel including but not limited to acorns, chestnuts, and/or hazelnuts. The aquatic species 906 may be organisms that live in water and/or are suitable for human consumption. The aquatic species 906 may be fish, shellfish, and/or other aquatic animals that are harvested and/or prepared as food.

The egg 908 may be a culinary ingredient that is commonly used in cooking and/baking. The egg 908 may be the reproductive body laid by female animals, typically birds such as chickens, and it may consist of a protective shell, egg white (albumen), and egg yolk. The soy 910 may be a product derived from soybeans which may also be legumes. The wheat 912 may be a cereal grain that is a staple food and one of the most widely cultivated and/or consumed cereal crops in many parts of the world. The fruit 914 may be a type of food that develops from the ovary of a flowering plant and may contain seeds. The vegetable 916 may be edible parts of plants that humans consume as food. The legume 918 may be the seeds of including but not limited to beans, lentils, chickpeas, peas, soybeans, and/or peanuts. The seed 920 may be a reproductive structure of plants that are used for growing new plants.

The additive 922 may be a substance added to food during the processing and/or preparation stage to enhance its flavor, texture, appearance, and/or shelf life. The additive 922 may serve various purposes including but not limited to as preserving freshness, improving color and/or taste, preventing spoilage, and/or maintaining nutritional content. The additive 922 may be natural and/or synthetic including but not limited to preservatives, food colors, flavors, sweeteners and/or emulsifiers.

As shown in FIG. 9, the allergy submodule 900 may automatically identify and/or inform the user 101 via the electronic device 102 of at least one allergic quality of the food ingredient 214. The allergy submodule 900 may receive information regarding the food ingredient 214 from the food information module 200 and assess whether the food ingredient 214 may contain dairy 902, nuts 904, aquatic species 906, eggs 908, soy 910, wheat 912, fruit 914, vegetables 916, legumes 918, seeds 920, and/or additives 922. The allergy submodule 900 may communicate these allergic qualities to the recipe submodule 600 to ensure the recipe submodule 600 is not recommending recipes that may be harmful to the user 101. Furthermore, the recipe submodule 600 and/or the marketplace submodule 500 may communicate information regarding the complementary item 506 to the allergy submodule to also ensure that the complementary item 506 does not have an allergic quality that may be harmful to the user 101.

The allergy submodule 900 may further communicate with the meal planning submodule 700 to ensure that any meal plans generated consider the identified allergic qualities of the user 101. This integration may allow the artificial intelligence model 150 to create personalized meal plans 708 that may align with the user's 101 dietary restrictions, thereby promoting a safer and/or healthier eating experience. In addition to interacting with the meal planning submodule 700, the allergy submodule 900 may collaborate with the drug interaction submodule 1000. This communication may aim to determine whether the allergic qualities of the food ingredient 214 may interact adversely with any medications the user 101 is currently taking and/or may consider in the future. Understanding potential drug interactions may be crucial for the user's 101A-N overall well-being, as certain combinations of foods and medications may have unintended consequences, ranging from diminished effectiveness to harmful side effects.

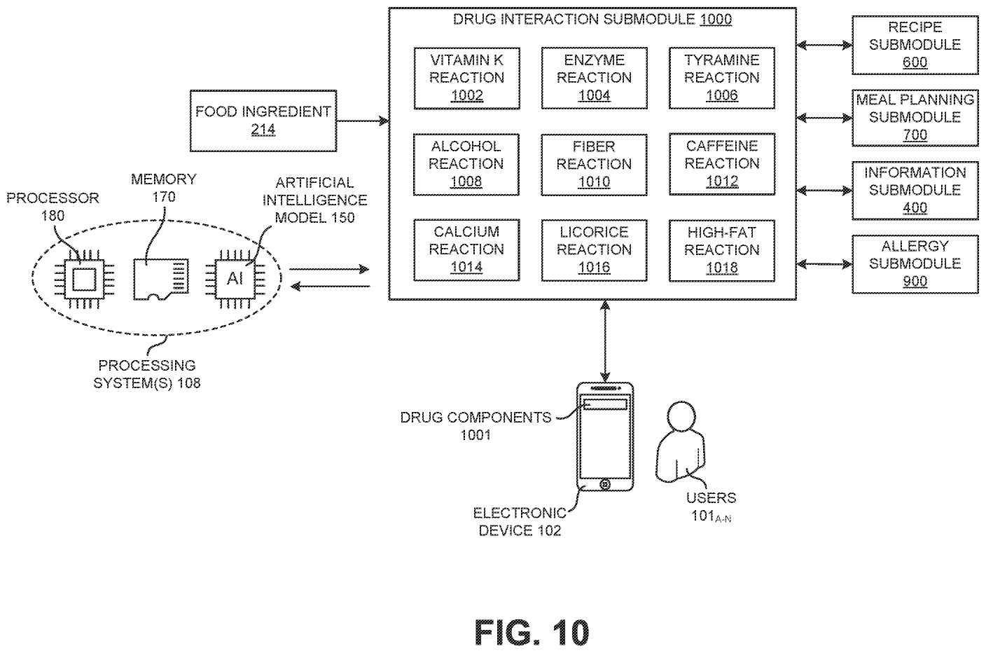

FIG. 10 is a schematic block diagram illustrating a drug interaction submodule 1000 of the automated food recognition platform 100 of FIG. 1 to identify and inform the user 101 via the electronic device 102 of at least one attribute 450 that may interact with at least one drug component 1001, according to one embodiment. FIG. 10 shows the user 101, the electronic device 102, the processing system 108 comprising the artificial intelligence model 150, the memory 170, and the processor 180, the food ingredient 214, the information submodule 400, the recipe submodule 600, the meal planning submodule 700, the allergy submodule 900, the drug interaction submodule 1000, a a vitamin k reaction 1002, an enzyme reaction 1004, a tyramine reaction 1006, an alcohol reaction 1008, a fiber reaction 1010, a caffeine reaction 1012, a calcium reaction 1014, a licorice reaction 1016, and a high-fat reaction 1018.

As shown in FIG. 10, the drug component 1001 may be any attribute and/or constituent of a drug and/or supplement that the user 101 is and/or has consumed, applied, injected, inhaled, and/or otherwise taken. The vitamin k reaction 1002 may be the process by which vitamin K is involved in a reaction with the drug component 1001. The enzyme reaction 1004 may be the process by which an enzyme is involved in a reaction with the drug component 1001. The tyramine reaction 1006 may be the potential interaction between tyramine-containing foods and the drug component 1001.

The alcohol reaction 1008 may be various chemical reactions involving alcohols. The alcohol reaction 1008 may be derived from vodka, beer, whiskey, cider, and/or alcohol powder. The fiber reaction 1010 may be the physiological response and/or effects of dietary fiber and medications. The caffeine reaction 1012 may be the effect of caffeine interaction with medications and/or drugs. The calcium reaction 1014 may refer to different chemical reactions between medication and/or drugs and foods containing calcium. The licorice reaction 1016 may be the reaction between licorice in foods and medications/drugs. The high-fat reaction 1018 may be the reaction between high-fat content in foods and medications/drugs.

As shown in FIG. 10, the drug interaction submodule 1000 may identify and/or inform the user 101 via the electronic device 102 of at least one attribute 450 that interacts with at least one drug component 1001 which may result in including but not limited to the vitamin k reaction 1002, the enzyme reaction 1004, the tyramine reaction 1006, the alcohol reaction 1008, the fiber reaction 1010, the caffeine reaction 1012, the calcium reaction 1014, the licorice reaction 1016, and/or the high-fat reaction 1018. The drug interaction submodule 1000 may analyze the specific attributes of these food reactions and their potential impact on medications. The drug interaction submodule 1000 may analyze the user's 101 specific drug regimen and may take into account the presence of the food ingredient 214 and/or their potential interactions. By utilizing the artificial intelligence model 150, the system may cross-reference the user's 101 medication profile with the known effects of each food ingredient 214. Furthermore, the recipe submodule 600 and/or the marketplace submodule 500 may communicate information regarding the complementary item 506 to the drug interaction submodule 1000 to also ensure that the complementary item 506 is does not have a quality that may interact with a drug the user 101 is taking and thus may be be harmful to the user 101.

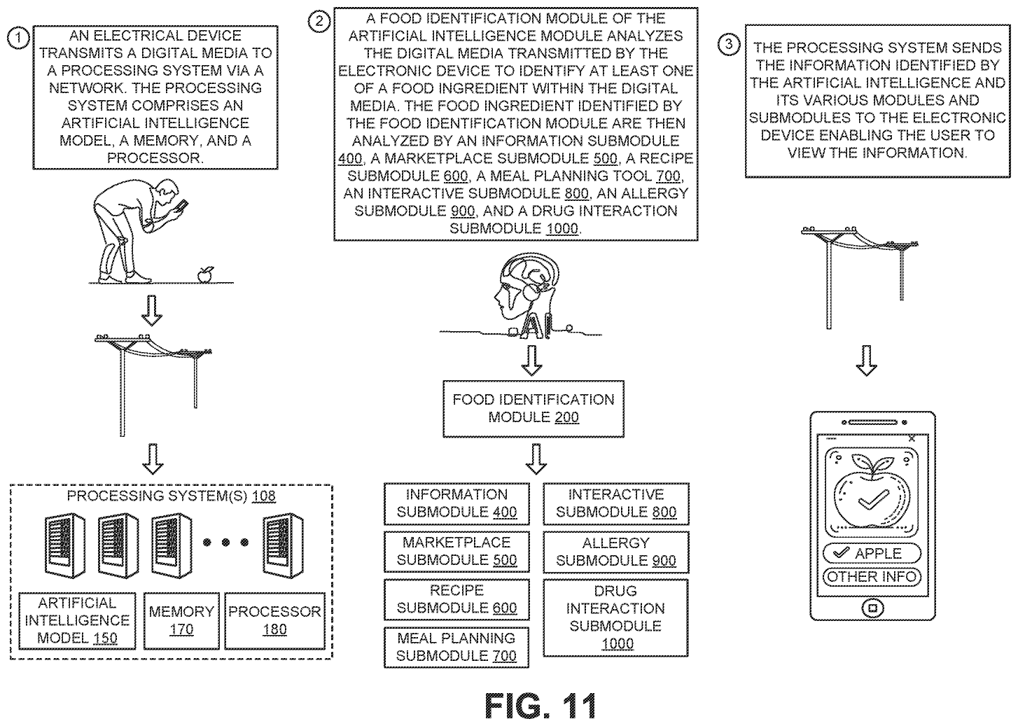

FIG. 11 is a representative view of the automated food recognition platform 100 which may recognize food items using artificial intelligence of FIGS. 1-10, according to one embodiment. In step ‘1’ of FIG. 11 an electrical device 102 may transmit a digital media 204 to a processing system 108 via a network 110. The processing system 108 may comprise an artificial intelligence model 150, a memory 170, and/or a processor 180. In step ‘2’ of FIG. 11 a food identification module 200 of the artificial intelligence module 150 may analyze the digital media 204 transmitted by the electronic device 102 to identify at least one of a food ingredient 214 within the digital media 204. The food ingredient 214 identified by the food identification module 200 may then be analyzed by an information submodule 400, a marketplace submodule 500, a recipe submodule 600, a meal planning submodule 700, an interactive submodule 800, an allergy submodule 900, and/or a drug interaction submodule 1000. In step ‘3’ of FIG. 11 the processing system 108 may send the information identified by the artificial intelligence model 150 and its various modules and submodules to the electronic device 102 which may enable the user 101A-N to view the information.

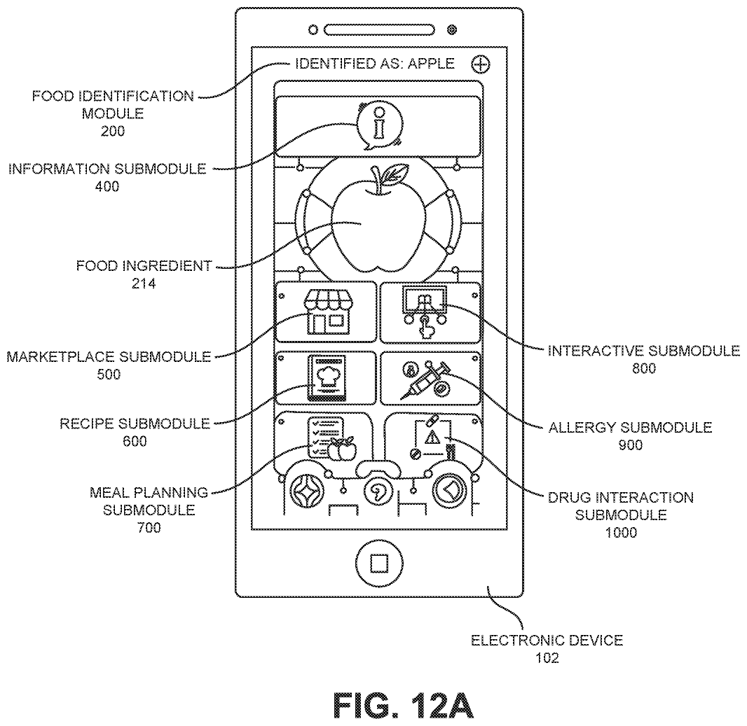

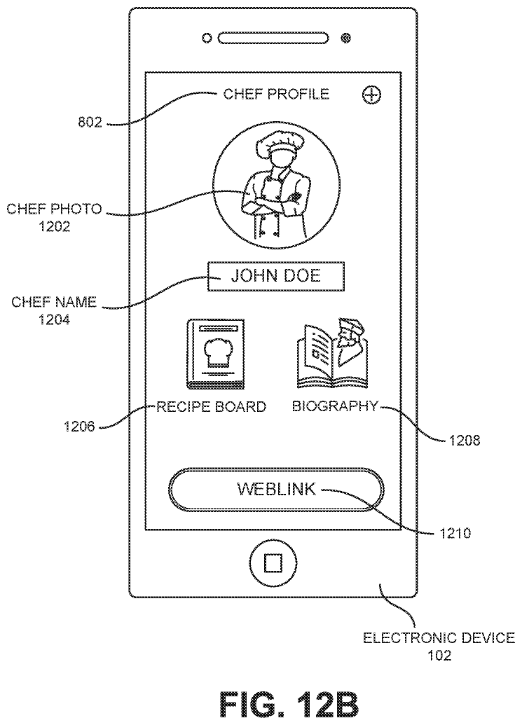

FIG. 12A is a user interface view of the electronic device 102 of the user 101 displaying food ingredient 214 using the food identification module 200, according to one embodiment. FIG. 12A shows the information submodule 400, the marketplace submodule 500, the recipe submodule 600, the meal planning submodule 700, the interactive submodule 800, the allergy submodule 900, and the drug interaction submodule 1000.

As shown in FIG. 12A, the electronic device 102 may display the food ingredient 214 as identified by the identification module 200 to the user 101. The information submodule 400 may display information related to the food ingredient 214 including but not limited to the food ingredient's 214 identity and/or a visual representation of the food ingredient 214. The information submodule 400 may further display in-depth nutritional content, including but not limited to calorie counts, micronutrient compositions, and/or the information about the origins of the food ingredient 214, offering insights into their geographical and/or cultural backgrounds. The marketplace submodule 500 may display the inventory levels 502, including but not limited to quantities available and/or expected restock dates of the food ingredient 214 across different vendors.

This submodule may allow users 101A-N to purchase ingredients, find suppliers, and/or explore new food products with the added convenience of viewing current stock availability of the food ingredient 214. The recipe submodule 600 may offer dynamic recipe suggestions and/or creations based on the food ingredient 214. The meal planning submodule 700 may display the meal plan 708 based on the food ingredient 214 and/or different aspects including but not limited to ingredients availability, user preferences, nutritional balance, dietary restrictions, and/or cooking abilities. The interactive submodule 800 may be capable of presenting interfaces for inputting various data including but not limited to dietary preferences 610, food ingredient 204, and/or user feedback 808. The interactive submodule 800 may further contain the user profile 806 and/or the chef profile 802. The allergy submodule 900 may display accurate and timely information about the presence of allergens in the food ingredient 214. The allergy submodule 900 may show alerts about allergens present in the food ingredient 214 based on the user's specific allergens. The drug interaction submodule 1000 may display potential interactions between drugs and the food ingredient 214 and/or may offer guidance on making informed dietary choices of the user 101 while taking medications.

FIG. 12B shows a user interface view of the electronic device 102 of the user 101 displaying the chef profile 802, a photo 1202, a chef name 1204, a recipe board 1206, a biography 1208, and/or a weblink 1210. As shown in FIG. 12B, the photo 1202 may be a profile photo of the individual chefs 106A-N and/or a visual representation of the chefs 106 on online platforms, social media, and/or other digital contexts. The photo 1202 may visually identify and/or personalize the chef's 106 chef profile 802, which may allow others to recognize and/or connect with the chef 106 more easily. The chefs 106A-N may choose the photo 1202 that reflects their personality, interests, and/or simply serves as a recognizable image of themselves.

The chef name 1204 may be the name associated with a chef's profile 802 and/or profile on a digital platform, website, social media, and/or any online service. It may be the chef name 1204 that other users and/or visitors see when interacting with that individual on the platform. The chef name 1204 may be chosen by the chef 106 during the registration process and/or may be their real name, a pseudonym, and/or any other identifier they prefer. The recipe board 1206 may refer to a digital and/or virtual platform for the chefs 106 designed to efficiently organize, discover, publicly post, and/or enhance their culinary creations. The recipe board 1206 may categorize various elements within a recipe, including but not limited to ingredients, cooking steps, and/or serving suggestions. The recipe board 1206 may show the custom recipe 616 of the chefs 106. The recipe board 1206 may aim to make the process of discovering, organizing, and/or utilizing recipes more efficient and enjoyable for the users 101A-N.

The biography 1208 may highlight the chef's 106 introductions, background, culinary journey, community engagement, achievements, and/or contributions to the world of gastronomy. The weblink 1210 may be a link to a website and/or web page associated with the chef 106 and/or automated food recognition platform 100. The weblink 1210 may be a website where the chef 106 utilizes and/or promotes automated food recognition platform 100. This may be a platform where the chef 106 discusses and/or showcases recipes, cooking techniques, and/or food-related content using and/or endorsing automated food recognition platform 100.

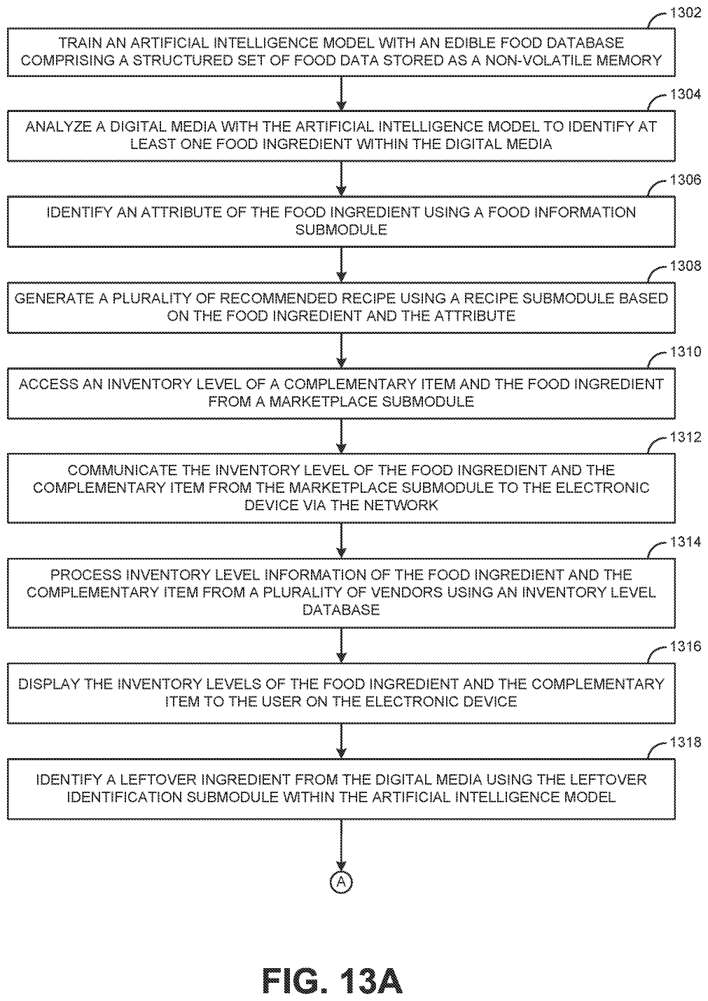

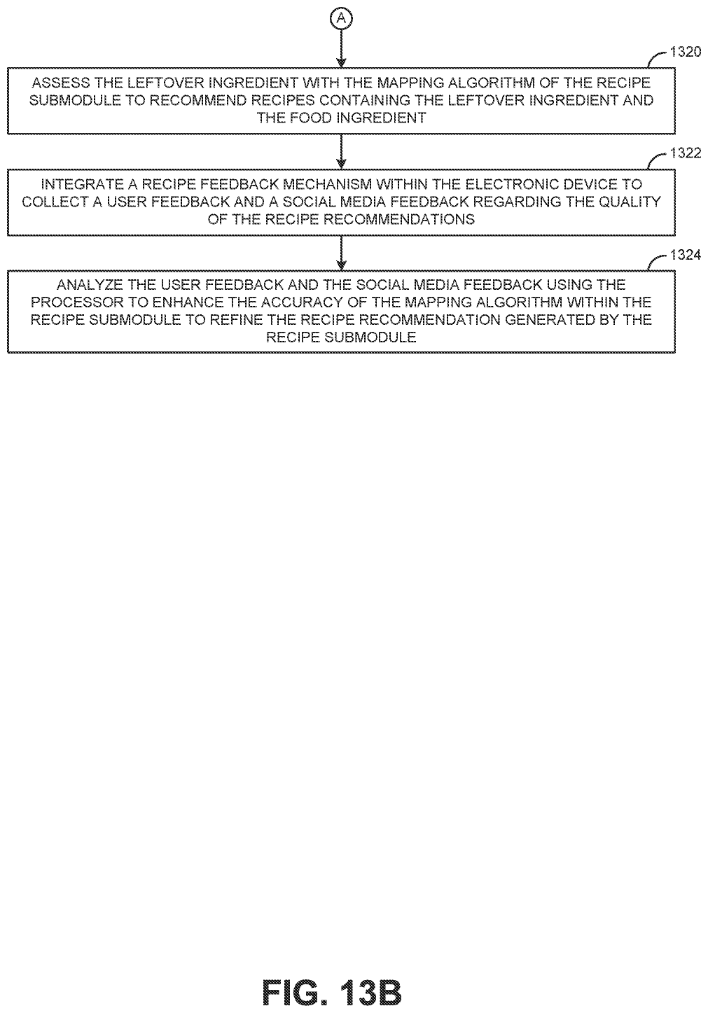

FIGS. 13A and 13B are process flow diagrams depicting the automated food recognition platform 100 to recognize food items using artificial intelligence, according to one embodiment of FIGS. 1-10. In operation 1302, an artificial intelligence model 150 may be trained with an edible food database 202 comprising a structured set of food data stored as a non-volatile memory. In operation 1304, a digital media 204 may be analyzed with the artificial intelligence model 150 to identify at least one food ingredient 214 within the digital media 204. In operation 1306, an attribute 450 of the food ingredient 214 may be identified using a food information submodule 400. In operation 1308, a plurality of recommended recipes 606 may be generated using a recipe submodule 600 based on the food ingredient 214 and the attribute 450. In operation 1310, an inventory level 508 of a complementary item 506 and the food ingredient 214 may be accessed from a marketplace submodule 500.

In operation 1312, the inventory level 508 of the food ingredient 214 and the complementary item 506 from the marketplace submodule 500 may communicate to the electronic device 102 via the network 110. In operation 1314, the inventory level 508 information of the food ingredient 214 and the complementary item within the marketplace submodule 506 may be processed from the vendor 106A-N using an inventory level database 504. In operation 1316, the inventory levels 508 of the food ingredient 214 and the complementary item 506 may be displayed to the user 101A-N on the electronic device 102. In operation 1318, a leftover ingredient 302 may be identified from the digital media 204 using the leftover identification submodule 300 within the artificial intelligence model 150. In operation 1320, the leftover ingredient 302 may be assessed with the mapping algorithm 604 of the recipe submodule 600 to recommend recipes containing the leftover ingredient 302 and the food ingredient 214. In operation 1322, a recipe feedback mechanism may integrate within the electronic device 102 to collect a user feedback 808 and a social media feedback 810 regarding the quality of the recipe recommendations 606. In operation 1324, the user feedback 808 and the social media feedback 810 may be analyzed using the processor 180 to enhance the accuracy of the mapping algorithm 604 within the recipe submodule 600 to refine the recipe recommendation 606 generated by the recipe submodule 600.

Food and food interest is an instinct spanning nearly all living organisms. For humans, food is not only a necessity, but also an activity that brings many joy and social inclusion. With food consumption and food interest also comes an increased need for food awareness. Food may be unhealthy and contrary to one's health goals. Food may also contain components-both natural and human made-that may be harmful to an eater. Furthermore, one may have general interest in food and may want to investigate a food's identity, origin, components, means of cooking, and/or availability at local vendors.

The embodiments of FIGS. 1-13B may allow a user the opportunity to properly and/or accurately investigate food from a digital media. The embodiments of FIGS. 1-13B may analyze a food item and determine various ingredients and components, giving users a helpful insight into what the food is, what components comprise the food, how the food may affect the user, how to prepare the food, and/or where to find/buy the food. The embodiments of FIGS. 1-13B may investigate fresh, cooked, prepared, and/or leftover food items and determine how best to prepare them. The embodiments of FIGS. 1-13B may add increased health to an increasingly processed food fed population while also promoting food awareness.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. An automated food recognition platform comprising:
a memory;
a processor communicatively coupled to the memory, the processor executing instructions stored in the memory;
an electronic device transmit a digital media to an artificial intelligence model via a network;
wherein the digital media is at least one of a digital media file, an image, a photograph, and an audiovisual media;
an edible food database stored on the memory as nonvolatile memory,
a food identification module within the artificial intelligence model to analyze the digital media transmitted by the electronic device to identify a food ingredient within the digital media, and
an information submodule to automatically identify an attribute of the food ingredient,
wherein the attribute is at least one of a source of origin, a taste profile, a nutritional content, a food component, and a cooking method of the food ingredient.

2. The automated food recognition platform of claim 1 further comprising:
a recipe database stored on the memory as nonvolatile memory;
a recipe submodule communicatively coupled to the recipe database and the food identification module,
wherein the recipe submodule receives outputs from the food identification module and the food information submodule and compares these outputs with a plurality of recipes listed in the recipe database using a mapping algorithm,
wherein the recipe submodule generates a recommended recipe for a user of the electronic device based on the outputs of the mapping algorithm, and
wherein the recipes within the recommended recipe contain the food ingredient.

3. The automated food recognition platform of claim 2 further comprising:
a structured set of food data formed from the digital media which is then stored within the edible food database,
wherein the artificial intelligence model is trained using the structured set of food data.

4. The automated food recognition platform of claim 1 further comprising:
an allergy submodule to automatically identify and inform the user via the electronic device of at least one allergic quality of the food ingredient.

5. The automated food recognition platform of claim 1 further comprising:
a drug interaction submodule to identify and inform the user via the electronic device of at least one attribute that interacts with at least one drug component.

6. The automated food recognition platform of claim 2 wherein the recipe submodule further considers at least one of a dietary preference, a food restriction, and a cooking skill level of the user when generating the recommended recipe.

7. The automated food recognition platform of claim 2 further comprising:
a marketplace submodule to identify an inventory level of a complementary item and the food ingredient at a vendor,
wherein the complementary item is part of the recommended recipe,
wherein the vendor communicates the inventory level of the food ingredient and the complementary item to the marketplace submodule over the network, and
wherein the inventory level of the food ingredient and the complementary item is communicated to the electronic device.

8. The automated food recognition platform of claim 7 further comprising:
an inventory level database that processes information from the vendor to update the vendor's inventory levels of the food ingredient and the complementary item within the marketplace submodule,
wherein the inventory levels of the food ingredient and the complementary item are viewable to the user on the electronic device.

9. The automated food recognition platform of claim 8 wherein the inventory level of the food ingredient and the inventory level of the complementary item for the vendors within the marketplace is input into the mapping algorithm of the recipe submodule and is used to refine selecting the recommended recipe.

10. The automated food recognition platform of claim 1 further comprising:
a leftover identification submodule within the artificial intelligence model to identify at least one leftover ingredient from the digital media,
wherein the leftover ingredient is input to the mapping algorithm of the recipe submodule, and
wherein the recipe submodule recommends the recommended recipe based on at least one of the leftover ingredient and the food ingredient.

11. The automated food recognition platform of claim 1 further comprising:
a meal planning submodule to allow the user to create a meal plan based on the recommended recipe and a secondary recipe identified by the recipe submodule,
wherein the meal planning submodule communicates with the marketplace submodule and recommends meal plans based on the inventory level of the complementary item in the plurality of vendors within a particular geographical region.

12. The automated food recognition platform of claim 1 further comprising:
an interactive submodule comprising an online community of a plurality of chefs,
wherein the chefs within the community of chefs have a chef profile displaying at least one of a chef name, a photo, a biography, a recipe board, and a weblink,
wherein the individual chefs may use the interactive submodule to share a custom recipe to at least one of the recipe database and the chef profile associated with that individual chef,
wherein the users may critique the custom recipe with a user feedback, and
wherein the user feedback is viewable on the chef profile associated with the custom recipe.

13. The automated food recognition platform of claim 12 wherein the mapping algorithm of the recipe submodule incorporates at least one of the user feedback and a social media feedback to refine the selection of the recommended recipe from the recipe submodule,
wherein the social media feedback is an automatically compiled dataset of comments about the custom recipe from a plurality of social media platforms,
wherein a chef rating is created from the user feedback and the social media feedback, and
wherein the chef rating is viewable on the chef profile.

14. The automated food recognition platform of claim 13 wherein the chefs receive a compensation based upon the chef rating generated from a recipe feedback and an interactions,
wherein the interactions are at least one of a recommendation frequency and a chef profile visits, and
wherein the recommendation frequency is the frequency that the chef's custom recipe is included in the recommended recipe output by the recipe submodule.

15. A method comprising:
training an artificial intelligence model with an edible food database comprising a structured set of food data stored as a non-volatile memory,
analyzing a digital media with the artificial intelligence model to identify at least one food ingredient within the digital media,
wherein the digital media is at least one of an image, a photograph, and an audiovisual media,
wherein the digital media is transferred to the artificial intelligence from an electronic device via a network,
wherein the digital media is a transformed into the structured set of food data and trains the artificial intelligence model;
identifying an attribute of the food ingredient using a food information submodule,
wherein the attribute is at least one of a source of origin, a taste profile, a nutritional content, a food component, and a cooking method;
generating a plurality of recommended recipes using a recipe submodule based on the food ingredient and the attribute,
wherein the food ingredient and the attribute are compared with the recipe database using a mapping algorithm,
wherein the recipe submodule generates the plurality of recommended recipes for a user of the electronic device based on at least one of a dietary preference, a food restriction, and a cooking skill level using the food ingredient, and
wherein the recipe contains the food ingredient.

16. The method of claim 15, further comprising:
accessing an inventory level of a complementary item and the food ingredient from a marketplace submodule,
wherein the complementary item is part of at least one of the recommended recipes;
communicating the inventory level of the food ingredient and the complementary item from the marketplace submodule to the electronic device via the network.

17. The method of claim 16, further comprising:
processing inventory level information of the food ingredient and the complementary item from a plurality of vendors using an inventory level database;
displaying the inventory levels of the food ingredient and the complementary item to the user on the electronic device.

18. The method of claim 15, further comprising:
identifying a leftover ingredient from the digital media using the leftover identification submodule within the artificial intelligence model;
assessing the leftover ingredient with the mapping algorithm of the recipe submodule to recommend recipes containing the leftover ingredient and the food ingredient.

19. The method of claim 15, further comprising:
integrating a recipe feedback mechanism within the electronic device to collect a user feedback and a social media feedback regarding the quality of the recipe recommendations,
wherein the user feedback and the social media feedback are analyzed by an interactive submodule using the processor to create a chef rating; and
analyzing the user feedback and the social media feedback using the processor to enhance the accuracy of the mapping algorithm within the recipe submodule to refine the recipe recommendations generated by the recipe submodule.

20. An automated food recognition system comprising:
a memory; and
a processor communicatively coupled to the memory, the processor executing instructions stored in the memory to:
intake a digital media from an electronic device using at least one of a camera and a file upload,
wherein the digital media is at least one of an image, a photograph, and an audiovisual media;
determine the presence of a food ingredient within the digital media by analyzing the digital media with an artificial intelligence model,
wherein the artificial intelligence model is trained using an edible food database,
wherein the edible food database contains a curated set of visual characteristics and identifying features for various food items and is designed to train the artificial intelligence model in accurately recognizing and identifying food items from the digital media, wherein the edible food database distinguishes between a locally sourced food ingredient and an imported ingredient based on the geographical location of the user; and
automatically identify at least one attribute of the food ingredient using a food information submodule,
wherein the at least one attribute is at least one of a source of origin, a taste profile, a nutritional content, a food component, and a cooking method of the food ingredient;
automatically inform the user via the electronic device of at least one allergic quality of the food ingredient using an allergy submodule within the food information submodule;
automatically inform the user via the electronic device of at least one attribute that interacts with at least one drug component;
automatically generate a plurality of recommended recipes with a recipe submodule, wherein the recipe submodule communicatively coupled to a recipe database and the food identification module,
wherein the recipe database is stored as a nonvolatile memory,
wherein the recipe submodule receives outputs from the food identification module and the food information submodule and compares these outputs with a plurality of recipes listed in the recipe database using a mapping algorithm,
wherein the recipe submodule generates the plurality of recommended recipes for a user of the electronic device based on the outputs of the mapping algorithm,
wherein the recipes within the plurality of recommended recipes contain the food ingredient,
wherein the recipes within the plurality of recommended recipes contain at least one of a complementary item that is combined with the food ingredient during a food preparation, and
wherein the recipe submodule considers at least one of a dietary preference, a food restriction, and a cooking skill level of the user when generating the plurality of recommended recipes.
assess an inventory level of the complementary item and the food ingredient at a vendor via a marketplace submodule and communicating the inventory level to the electronic device,
wherein the vendor communicates the inventory level of the food ingredient and the complementary item to the marketplace submodule over the network,
wherein an inventory level database processes information from the vendor to update their inventory levels of the food ingredient and the complementary item within the marketplace submodule,
wherein the inventory levels of the food ingredient and the complementary item are viewable to the user on the electronic device, and
wherein the inventory level of the food ingredient and the inventory level of the complementary item for the vendor within the marketplace is input into the mapping algorithm of the recipe submodule and used to refine the plurality of recommended recipes;
identify at least one leftover ingredient from the digital media using a leftover identification submodule of the artificial intelligence model,
wherein the leftover ingredient is input to the mapping algorithm of the recipe submodule, and
wherein the recipe submodule recommends the plurality of recipes based on the at least one of the leftover ingredient and the food ingredient,
create a meal plan using a meal planning submodule based on the plurality of recommended recipes and secondary recipes identified by the recipe submodule,
wherein the meal planning submodule communicates with the marketplace submodule and recommends meal plans based on an inventory level of the complementary item at the vendor within a particular geographical region.
facilitate interaction between a community of chefs and the users via an interactive submodule,
wherein the individual chefs within the community of chefs have a chef profile displaying at least one of a chef name, a photo, a biography, a recipe board, and a weblink,
wherein the individual chefs may use the interactive submodule to share a custom recipe to at least one of the recipe database and the chef profile associated with that individual chef,
wherein users may critique the custom recipe with a user feedback,
wherein the user feedback is viewable on the chef profile associated with the custom recipe,
wherein the mapping algorithm of the recipe submodule incorporates at least one of the user feedback and a social media feedback to refine the selection of the plurality of recommended recipes from the recipe submodule,
wherein the social media feedback is an automatically compiled dataset of comments about the custom recipe from a plurality of social media platforms,
wherein a chef rating is created from the user feedback and the social media feedback,
wherein the chef rating is viewable on the chef profile,
wherein the chefs promote their custom recipes on the interactive submodule using a paid advertising service within the interactive submodule,
wherein the chefs receive a compensation based upon the chef rating generated from a recipe feedback and an interaction,
wherein the interaction are at least one of a recommendation frequency and a chef profile visits, and
wherein the recommendation frequency is the frequency that a chef's custom recipe is included in the plurality of recommended recipes output by the recipe submodule.
